(19) United States
(12) Patent Application Publication
(10) Pub. No.: US 2026/0172905 A1
(43) Pub. Date: Jun. 18, 2026

(54) WIRELESS COMMUNICATION METHOD AND COMMUNICATIONS DEVICE

(71) Applicant: QUECTEL WIRELESS SOLUTIONS CO., LTD., Shanghai (CN)

(72) Inventors: Qufang HUANG, Shanghai (CN); Zheng ZHAO, Shanghai (CN)

(21) Appl. No.: 19/450,195

(22) Filed: Jan. 15, 2026

Related U.S. Application Data
(63) Continuation of application No. PCT/CN2024/139298, filed on Dec. 13, 2024.

(51) Int. Cl. H04W 28/22

(52) U.S. Cl. CPC H04W 28/22

(57) ABSTRACT

Provided are a wireless communication method and a communications device. One example method includes: receiving, by a terminal device, first information from a network device, wherein the first information is used to determine at least one of an uplink rate or a downlink rate of a first service, and an association relationship exists between the uplink rate and the downlink rate.

### CROSS-REFERENCE TO RELATED APPLICATIONS

This application is a continuation of International Application No. PCT/CN2024/139298, filed on Dec. 13, 2024, the disclosure of which is hereby incorporated by reference in its entirety.

### TECHNICAL FIELD

The present application relates to the field of communications technologies, and more specifically, to a wireless communication method and a communications device.

### BACKGROUND

In a communications system, rate adjustment of a first service (for example, an extended reality (extended reality, XR) service) is implemented through inter-application layer negotiation. However, this rate adjustment manner is relatively slow, which may affect data transmission of the first service.

### SUMMARY

The present application provides a wireless communication method and a communications device. Various aspects involved in the present application are described below.

According to a first aspect, a wireless communication method is provided, including: receiving, by a terminal device, first information transmitted by a network device, where the first information is used to determine an uplink rate and/or a downlink rate of a first service, and an association relationship exists between the uplink rate and the downlink rate.

According to a second aspect, a wireless communication method is provided, including: transmitting, by a network device, first information to a terminal device and/or a first network element, where the first information is used to determine an uplink rate and/or a downlink rate of a first service, and an association relationship exists between the uplink rate and the downlink rate.

According to a third aspect, a wireless communication method is provided, including: receiving, by a first network element, first information transmitted by a network device, where the first information is used to determine an uplink rate and/or a downlink rate of a first service, and an association relationship exists between the uplink rate and the downlink rate.

According to a fourth aspect, a communications device is provided. The communications device is a terminal device. The communications device includes: a receiving unit, receiving first information transmitted by a network device, where the first information is used to determine an uplink rate and/or a downlink rate of a first service, and an association relationship exists between the uplink rate and the downlink rate.

According to a fifth aspect, a communications device is provided. The communications device is a network device. The communications device includes: a transmitting unit, transmitting first information to a terminal device and/or a first network element, where the first information is used to determine an uplink rate and/or a downlink rate of a first service, and an association relationship exists between the uplink rate and the downlink rate.

According to a sixth aspect, a communications device is provided. The communications device is a first network element. The communications device includes: a receiving unit, receiving first information transmitted by a network device, where the first information is used to determine an uplink rate and/or a downlink rate of a first service, and an association relationship exists between the uplink rate and the downlink rate.

According to a seventh aspect, a communications device is provided, including a transceiver, a memory, and a processor. The memory is configured to store a program. The processor is configured to: invoke the program in the memory, and control the transceiver to receive or transmit a signal, to cause the communications device to perform the method according to the foregoing aspects.

According to an eighth aspect, an embodiment of the present application provides a communications system. The system includes the foregoing communications device. In another possible design, the system may further include another device that interacts with the communications device in the solutions provided in embodiments of the present application.

According to a ninth aspect, an embodiment of the present application provides a computer-readable storage medium. The computer-readable storage medium stores a computer program. The computer program causes a communications device to perform a part or all of the steps in the method according to the foregoing aspects.

According to a tenth aspect, an embodiment of the present application provides a computer program product. The computer program product includes a non-transitory computer-readable storage medium storing a computer program, and the computer program is operable to cause a communications device to perform a part or all of the steps of the method according to the foregoing aspects. In some implementations, the computer program product may be a software installation package.

According to an eleventh aspect, an embodiment of the present application provides a chip. The chip includes a memory and a processor. The processor may invoke a computer program from the memory and run the computer program, to implement a part or all of steps described in the method according to the foregoing aspects.

In the present application, the network device transmits the first information to the terminal device and/or the first network element. The first information is used to determine the uplink rate and/or the downlink rate of the first service. An association relationship exists between the uplink rate and the downlink rate. The network device transmits the first information to the terminal device and/or the first network element, to adjust a rate of the first service, thereby omitting negotiation of an application layer. This does not require additional air interface message transmission, which facilitates speed-up of a rate adjustment procedure of the first service.

### BRIEF DESCRIPTION OF THE DRAWINGS

FIG. 1 shows a wireless communications system 100 to which an embodiment of the present application is applied.

FIG. 2 is an example diagram of a rate determining and adjustment procedure of an XR service.

FIG. 3 is a schematic flowchart of a wireless communication method according to an embodiment of the present application.

FIG. 4 is an example diagram of a method for adjusting a first service rate according to an embodiment of the present application.

FIG. 5 is an example diagram of a method for adjusting a first service rate according to another embodiment of the present application.

FIG. 6 is an example diagram of a method for adjusting a first service rate according to still another embodiment of the present application.

FIG. 7 is an example diagram of a method for adjusting a first service rate according to yet another embodiment of the present application.

FIG. 8 is a schematic diagram of a structure of a communications device according to an embodiment of the present application.

FIG. 9 is a schematic diagram of a structure of a communications device according to another embodiment of the present application.

FIG. 10 is a schematic diagram of a structure of a communications device according to still another embodiment of the present application.

FIG. 11 is a schematic diagram of a structure of an apparatus according to an embodiment of the present application.

### DETAILED DESCRIPTION OF THE EMBODIMENTS

The technical solutions in the present application are described below with reference to the accompanying drawings.

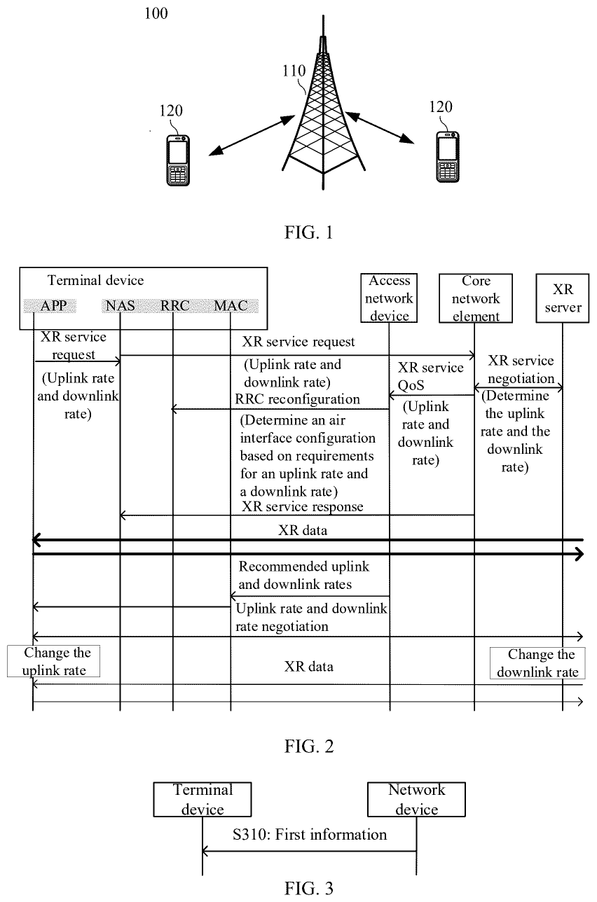

FIG. 1 shows a wireless communications system 100 to which embodiments of the present application are applied. The wireless communications system 100 may include a network device 110 and terminal devices 120. The network device 110 may be a device that communicates with the terminal device 120. The network device 110 may provide communication coverage for a specific geographic area, and may communicate with the terminal device 120 located within the coverage.

FIG. 1 schematically shows one network device and two terminals. Optionally, the wireless communications system 100 may include a plurality of network devices, and another quantity of terminal devices may be included within coverage of each network device. This is not limited in embodiments of the present application.

Optionally, the wireless communications system 100 may further include other network entities such as a network controller and a mobility management entity. This is not limited in embodiments of the present application.

It should be understood that the technical solutions of embodiments of the present application may be applied to various communications systems, such as a 5th generation (5th generation, 5G) system or a new radio (new radio, NR) system, a long-term evolution (long term evolution, LTE) system, an LTE frequency division duplexing (frequency division duplex, FDD) system, and an LTE time division duplexing (time division duplex, TDD) system. The technical solutions provided in the present application may further be applied to a future communications system, such as a 6th generation mobile communications system or a satellite communications system.

The terminal device in embodiments of the present application may also be referred to as a user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relay of a communication signal through a base station.

A network device in embodiments of the present application may be a device for communicating with the terminal device. The network device may also be referred to as an access network device or a radio access network device. For example, the network device may be a base station. The network device in embodiments of the present application may be a radio access network (radio access network, RAN) node (or device) that connects the terminal device to a wireless network. The base station may broadly cover the following various names, or may be interchanged with the following names, such as a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNode (MeNB), a secondary eNode (SeNB), a multi-standard radio (MSR) node, a home base station, a network controller, an access node, a radio node, an access point (access point, AP), a transmission node, a transceiver node, a baseband unit (baseband unit, BBU), a remote radio unit (Remote Radio Unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device (D2D), vehicle-to-everything (vehicle-to-everything, V2X), and machine-to-machine (machine-to-machine, M2M) communication, a network-side device in a 6G network, a device that functions as a base station in a future communications system, or the like. The base station may support networks of a same access technology or different access technologies. A specific technology and a specific device used by the network device are not limited in embodiments of the present application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or a part of functions of the communications device in the present application may also be implemented by software functions running on hardware, or by virtualization functions instantiated on a platform (for example, a cloud platform).

The introduction of a 5G network greatly improves a transmission data rate that can be implemented over the network, and can support a first service that requires high-rate transmission. Because a rate of the first service is high, fast adjustment is required to adapt to a network environment.

In some implementations, the first service may be an extended reality (extended reality, XR) service. For example, the first service may be an augmented reality (augmented reality, AR) service, a virtual reality (virtual reality, VR) service, or a mixed reality (mixed reality, MR) service.

For example, the first service is an XR service. A feature of the XR service is a large data volume, a high requirement for a data transmission rate, a strict delay requirement for data transmission, and all indices far higher than those of an existing service. Therefore, even in a 5G network, it is difficult to support a large quantity of terminal devices to transmit XR services at the same time. In addition, most XR service data belongs to video-type data. A service rate of video-type data depends on video coding. If video coding is relatively meticulous and high-definition, the data volume is large; or otherwise, if definition is slightly reduced in video coding, the data volume decreases. The data volume temporarily decreases. For a user, the data rate temporarily decreases. This cannot be immediately sensed. This feature of video coding provides space for rate adjustment of the XR service. The network may temporarily adjust the XR service rate of the terminal device during congestion, and then resume the XR service rate after the congestion ends.

In a communications system, rate adjustment of the first service is implemented through inter-application layer negotiation. However, this rate adjustment manner is relatively slow, which may affect data transmission of the first service.

The following describes a related procedure of determining and adjusting a first service rate with reference to FIG. 2 by using an example in which the first service is an XR service.

In FIG. 2, if an XR service needs to be established at an XR application (application, APP) layer of a terminal device, an XR service request is initiated by using a non-access stratum (non access stratum, NAS) message, where the non-access stratum message includes an uplink rate and a downlink rate that are requested by the XR application layer on a terminal device side. A core network element receives the request; obtains a quality of service (quality of service, QoS) parameter of the XR service from an XR server (server), including an uplink rate, a downlink rate, a delay budget, and the like; and notifies an access network device (for example, a gNB). The access network device determines, based on the QoS parameter, a radio interface parameter corresponding to the XR service, and configures, for the terminal device by using a radio resource control (radio resource control, RRC) reconfiguration message, a wireless parameter suitable for the XR service. In addition, the core network element transmits a NAS message to the terminal device, that is, an “XR service response” in FIG. 2, to configure a NAS parameter for the terminal device. After the procedure is completed, transmission of XR data is started, and a data transmission rate of the XR data is processed according to a manner of processing the uplink rate and the downlink rate described in the service establishment procedure. It should be noted that the core network element in FIG. 2 actually includes a plurality of specific network elements. For example, for 5G, the network element may be an access and mobility management function (access and mobility management function, AMF) and a session management function (session management function, SMF). Because the two nodes are different in division of labor, the AMF directly interacts with the access network device and the terminal device. A specific parameter of the XR service is determined by the SMF. In FIG. 2, the AMF and the SMF are represented by using the core network elements.

If a radio interface status changes in a transmission process, and a rate of an XR service that can be supported changes correspondingly, the access network device and the terminal device interact, by using a medium access control control element (medium access control control element, MAC CE), with each other about a service rate that is expected to be adjusted, and then a medium access control (medium access control, MAC) entity of the terminal device notifies an application layer of the terminal device. Specifically, the access network device notifies the terminal device of the expected uplink rate and the expected downlink rate by using a MAC CE “Recommended bit rate MAC CE”. After the MAC entity of the terminal device learns of the expected uplink rate and the expected downlink rate, the application layer of the terminal device is notified by using inter-layer primitives. After the application layer of the terminal device learns of the expected rates of the radio interface, the application layer of the terminal device negotiates with the XR server by using an application layer procedure. After agreement is reached between the two parties, the application layer of the terminal device and the XR server adjust their encoding parameters based on the expected rates of the radio interface, so that an encoder outputs a data stream according to an expected output rate. In the example shown in FIG. 2, reduction of the XR data rate is used as an example. A thick line indicates a large data transmission rate, and a thin line indicates a small data transmission rate.

Two problems exist in the foregoing procedure: One problem is that when the uplink rate and the downlink rate of the XR service are negotiated between application layers, a response to rate adjustment is slow. Another problem is that when the uplink rate and the downlink rate of the XR service are negotiated between application layers, transmission of additional air interface messages is required. If a large quantity of users brings about network congestion, transmission of these additional control messages requires a long time of waiting, or worsens the air interface. The messages need to be transmitted for a longer time. In both cases, duration of the negotiation procedure becomes longer.

For the foregoing problem, an embodiment of the present application provides a wireless communication method. A network device transmits first information to a terminal device and/or a first network element. The first information is used to determine an uplink rate and/or a downlink rate of a first service. An association relationship exists between the uplink rate and the downlink rate. The network device transmits the first information to the terminal device and/or the first network element, to adjust a rate of the first service, thereby omitting negotiation of an application layer. This does not require additional air interface message transmission, which facilitates speed-up of a rate adjustment procedure of the first service.

The following describes the wireless communication method according to this embodiment of the present application with reference to FIG. 3. FIG. 3 is a schematic flowchart of a wireless communication method according to an embodiment of the present application. The method shown in FIG. 3 includes step S310.

Step S310: A network device transmits first information to a terminal device. Accordingly, the terminal device receives the first information transmitted by the network device.

In some implementations, the network device may also transmit the first information to a first network element. Correspondingly, the first network element receives the first information transmitted by the network device.

In some implementations, the first information transmitted by the network device to the first network element is forwarded to the first network element by using another network element.

In some implementations, the another network element may be a core network element, and the core network element includes an AMF and/or an SMF. For example, the network device is an access network device, the access network device notifies the AMF of the first information, and the AMF forwards the first information to the first network element. For another example, the access network device notifies the AMF of the first information, the AMF forwards the first information to the SMF, and the SMF forwards the first information to the first network element after obtaining the first information.

It should be noted that the first network element may be a server of a first service. For example, the first network element is the foregoing XR server.

In some implementations, the first information is used to determine an uplink rate and/or a downlink rate of the first service. In other words, the uplink rate and/or the downlink rate of the first service may be determined based on the first information.

In some implementations, the uplink rate of the first service may be understood as an updated transmission rate of uplink data of the first service, or an adjusted transmission rate of uplink data of the first service.

In some implementations, the downlink rate of the first service may be understood as an updated transmission rate of downlink data of the first service, or an adjusted transmission rate of downlink data of the first service.

In some implementations, an association relationship exists between the uplink rate of the first service and the downlink rate of the first service, that is, a correlation exists between the uplink rate of the first service and the downlink rate of the first service.

In some implementations, the first association information may be used to indicate the association relationship between the uplink rate of the first service and the downlink rate of the first service.

In some implementations, the first association information includes one or more of the following: a first index; the uplink rate; the downlink rate; a range of the uplink rate; a range of the downlink rate; or a first parameter.

In some implementations, the first index is used to indicate a combination of the uplink rate and the downlink rate, or a combination of the range of the uplink rate and the range of the downlink rate. For example, with reference to Table 1, when the first index is 0, it indicates that the uplink rate is A, and the associated downlink rate is A′. For another example, with reference to Table 2, when the first index is 1, it indicates that the range of the uplink rate is [C, D], and the associated range of the downlink rate is [C′, D′].

TABLE 1

| Index value | Uplink rate | Downlink rate |
|---|---|---|
| 0 | A | A′ |
| 1 | B | B′ |
| 2 | C | C′ |

TABLE 2

| | Range of the | Range of the |
|---|---|---|
| Index value | uplink rate | downlink rate |
| 0 | [A, B] | [A′, B′] |
| 1 | [C, D] | [C′, D′] |
| 2 | [E, F] | [E′, F′] |

In some implementations, the first parameter is used to implement one or more of the following: determining the downlink rate based on the uplink rate; determining the range of the downlink rate based on the range of the uplink rate; determining the uplink rate based on the downlink rate; or determining the range of the uplink rate based on the range of the downlink rate.

In some implementations, if the first parameter is used to determine the downlink rate based on the uplink rate, or determine the uplink rate based on the downlink rate, the first parameter may be used to indicate one or more of the following: an offset value between the uplink rate and the downlink rate; a ratio between the uplink rate and the downlink rate; or a ratio between the downlink rate and the uplink rate.

In some implementations, if the first parameter is used to determine the range of the downlink rate based on the range of the uplink rate, or determine the range of the downlink rate based on the range of the uplink rate, the first parameter may be used to indicate one or more of the following: an offset value between an upper boundary of the range of the uplink rate and an upper boundary of the range of the downlink rate; an offset value between a lower boundary of the range of the uplink rate and a lower boundary of the range of the downlink rate; a ratio between an upper boundary of the range of the downlink rate and an upper boundary of the range of the uplink rate; a ratio between a lower boundary of the range of the downlink rate and a lower boundary of the range of the uplink rate; a ratio between an upper boundary of the range of the uplink rate and an upper boundary of the range of the downlink rate; or a ratio between a lower boundary of the range of the uplink rate and a lower boundary of the range of the downlink rate.

In some implementations, the first association information includes a first index. Correspondingly, the uplink rate and the downlink rate may be determined based on the first index. For example, the first association information includes the first index, and the first index is an index value 2 in Table 1. Based on the first index, it may be determined that the uplink rate is C, and the downlink rate is C′.

In some implementations, the first association information includes the uplink rate and the downlink rate. For example, with reference to Table 1, the first association information includes uplink rates: A, B, and C, and downlink rates associated with the uplink rates: A′, B′, and C′.

In some implementations, the uplink rate and the downlink rate that are included in the first association information may be the same or different. For example, with reference to Table 1, the first association information includes the uplink rate A and the downlink rate A′, where A may be the same as or different from A′.

In some implementations, if the uplink rate is the same as the downlink rate, the first association information may include only the uplink rate or only the downlink rate.

In some implementations, the first association information includes the range of the uplink rate and the range of the downlink rate. For example, with reference to Table 2, the first association information includes uplink rate ranges: [A, B], [C, D], and [E, F], and downlink rate ranges associated with the uplink rate ranges: [A′, B′], [C′, D′], and [E′, F′].

In some implementations, the range of the uplink rate and the range of the downlink rate that are included in the first association information may be the same or different. With reference to Table 2, the first association information includes the uplink rate range [A, B] and the downlink rate range [A′, B′] associated with the uplink rate range, where [A, B] may be the same as or different from [A′, B′].

In some implementations, if the range of the uplink rate is the same as the range of the downlink rate, the first association information may include only the range of the uplink rate or only the range of the downlink rate.

In some implementations, the first association information includes the uplink rate and the first parameter, the first parameter includes a first offset value, and the first offset value is used to indicate the offset value between the uplink rate and the downlink rate. Correspondingly, the downlink rate may be determined based on the first offset value and the uplink rate. For example, with reference to Table 3, the first association information includes uplink rates: A, B, and C, and first offset values, and the first offset values include A_offset, B_offset, and C_offset. Correspondingly, based on the first offset values and the uplink rates: A, B, and C, it may be determined that downlink rates associated with the uplink rates: A, B, and C are A+A_offset, B+B_offset, and C+C_offset.

TABLE 3

| Index value | Uplink rate | Downlink rate |
|---|---|---|
| 0 | A | A + A_offset |
| 1 | B | B + B_offset |
| 2 | C | C + C_offset |

In some implementations, the first association information includes the downlink rate and the first parameter, the first parameter includes a first offset value, and the first offset value is used to indicate the offset value between the uplink rate and the downlink rate. Correspondingly, the uplink rate may be determined based on the first offset value and the downlink rate. For example, the first association information includes downlink rates: A′, B′, and C′, and first offset values include A′_offset, B′_offset, and C′_offset. Correspondingly, based on the first offset values and the downlink rates: A′, B′, and C′, it may be determined that uplink rates associated with the downlink rates: A′, B′, and C′ are A′+A′_offset, B′+B′_offset, and C′+C′_offset.

In some implementations, the first offset value may be a positive value, or may be a negative value. For example, with reference to Table 3, the first offset value includes A_offset, and A_offset may be a positive value or a negative value. If A_offset is a positive value, the downlink rate is greater than the uplink rate. If A_offset is a negative value, the downlink rate is less than the uplink rate. It should be noted that an absolute value of A_offset should be less than A when A_offset is a negative value, to ensure that the downlink rate is greater than 0.

In some implementations, the first association information includes the range of the uplink rate and the first parameter. The first parameter includes a second offset value and a third offset value. The second offset value is used to indicate the offset value between the lower boundary of the range of the uplink rate and the lower boundary of the range of the downlink rate. The third offset value is used to indicate the offset value between the upper boundary of the range of the uplink rate and the upper boundary of the range of the downlink rate. Correspondingly, the range of the downlink rate may be determined based on the second offset, the third offset, and the range of the uplink rate. For example, with reference to Table 4, the first association information includes uplink rate ranges: [A, B], [C, D], and [E, F], second offset values, and third offset values. The second offset values include A_offset, C_offset, and E_offset. The third offset values include B_offset, D_offset, and F_offset. Correspondingly, based on the second offset values, the third offset values, and the uplink rate ranges: [A, B], [C, D], and [E, F], it may be determined that downlink rate ranges associated with the uplink rate ranges: [A, B], [C, D], and [E, F] are [A+A_offset, B+B_offset], [C+C_offset, D+D_offset], and [E+E_offset, F+F_offset].

TABLE 4

| Index | Range of the | Range of the |
|---|---|---|
| value | uplink rate | downlink rate |
| 0 | [A, B] | [A + A_offset, B + B_offset] |
| 1 | [C, D] | [C + C_offset, D + D_offset] |
| 2 | [E, F] | [E + E_offset, F + F_offset] |

In some implementations, the first association information includes the range of the downlink rate and the first parameter. The first parameter includes a second offset value and a third offset value. The second offset value is used to indicate the offset value between the lower boundary of the range of the uplink rate and the lower boundary of the range of the downlink rate. The third offset value is used to indicate the offset value between the upper boundary of the range of the uplink rate and the lower boundary of the range of the uplink rate. Correspondingly, the range of the uplink rate may be determined based on the second offset, the third offset, and the range of the downlink rate. For example, the first association information includes downlink rate ranges: [A′, B′], [C′, D′], and [E′, F′], second offset values, and third offset values. The second offset values include A′_offset, C′_offset, and E′_offset. The third offset values include B′_offset, D′_offset, and F′_offset. Correspondingly, based on the second offset values, the third offset values, and the downlink rate ranges: [A′, B′], [C′, D′], and [E′, F′], it may be determined that uplink rate ranges associated with the downlink rate ranges: [A′, B′], [C′, D′], and [E′, F′] are [A′+A′_offset,B′+B′_offset], [C′+C′_offset, D′+D′_offset], and [E′+E′_offset, F′+F′_offset].

In some implementations, at least one of the second offset value or the third offset value may be a positive value or a negative value.

In some implementations, the second offset value may be the same as or different from the third offset value. For example, with reference to Table 4, when the index value is 0, the second offset value includes A_offset, and the third offset value includes B_offset, where A_offset may be the same as or different from B_offset.

In some implementations, if the second offset value is the same as the third offset value, the first association information may include at least one of the second offset value and the third offset value. For example, with reference to Table 4, when the index value is 0, the second offset value includes A_offset, and the third offset value includes B_offset. If A_offset is the same as B_offset, the first association information may include at least one of A_offset and B_offset.

In some implementations, the first association information includes the uplink rate and the first parameter, the first parameter includes a first ratio, and the first ratio is used to indicate the ratio between the downlink rate and the uplink rate. For example, with reference to Table 5, the first association information includes uplink rates: A, B, and C, and first ratios, and the first ratios include k_a, k_b, and k_c. Correspondingly, based on the first ratios and the uplink rates: A, B, and C, it may be determined that downlink rates associated with the uplink rates: A, B, and C are A*k_a, B*k_b, and C*k_c.

TABLE 5

| Index value | Uplink rate | Downlink rate |
|---|---|---|
| 0 | A | A * k_a |
| 1 | B | B * k_b |
| 2 | C | C * k_c |

In some implementations, the first association information includes the downlink rate and the first parameter, the first parameter includes a second ratio, and the second ratio is used to indicate the ratio between the uplink rate and the downlink rate. Correspondingly, the uplink rate may be determined based on the second ratio and the downlink rate. For example, the first association information includes downlink rates: A′, B′, and C′, and second ratios, and the second ratios include k_a′, k_b′, and k_c′. Correspondingly, based on the second ratios and the downlink rates: A′, B′, and C′, it may be determined that uplink rates associated with the downlink rates: A′, B′, and C′ are A′ *k_a′, B′ *k_b′, and C′ *k_c′.

In some implementations, the first association information includes the range of the uplink rate and the first parameter, the first parameter includes a third ratio and a fourth ratio, the third ratio is used to indicate the ratio between the lower boundary of the range of the downlink rate and the lower boundary of the range of the uplink rate, and the fourth ratio is used to indicate the ratio between the upper boundary of the range of the downlink rate and the upper boundary of the range of the uplink rate. Correspondingly, the range of the downlink rate may be determined based on the range of the uplink rate, the third ratio, and the fourth ratio. For example, with reference to Table 6, the first association information includes uplink rate ranges: [A, B], [C, D], and [E, F], third ratios, and fourth ratios. The third ratios include k_a, k_c, and k_e. The fourth ratios include k_b, k_d, and k_f. Correspondingly, based on the third ratios, the fourth ratios, and the uplink rate ranges: [A, B], [C, D], and [E, F], it may be determined that downlink rate ranges associated with the uplink rate ranges: [A, B], [C, D], and [E, F] are [A*k_a, B*k_b], [C*k_c, D*k_d], and [E*k_e, F*k_f].

TABLE 6

| Index | Range of the | Range of the |
|---|---|---|
| value | uplink rate | downlink rate |
| 0 | [A, B] | [A * k_a, B * k_b] |
| 1 | [C, D] | [C * k_c, D * k_d] |
| 2 | [E, F] | [E * k_e, F * k_f] |

In some implementations, the first association information includes the range of the downlink rate and the first parameter, the first parameter includes a fifth ratio and a sixth ratio, the fifth ratio is used to indicate the ratio between the lower boundary of the range of the uplink rate and the lower boundary of the range of the downlink rate, and the sixth ratio is used to indicate the ratio between the upper boundary of the range of the uplink rate and the upper boundary of the range of the downlink rate. Correspondingly, the range of the uplink rate may be determined based on the range of the downlink rate, the fifth ratio, and the sixth ratio. For example, the first association information includes downlink rate ranges: [A′, B′], [C′, D′], and [E′, F′], fifth ratios, and sixth ratios. The fifth ratios include k_a′, k_c′, and k_e′. The sixth ratios include k_b′, k_d′, and k_f′. Correspondingly, based on the fifth ratios, the sixth ratios, and the downlink rate ranges: [A′, B′], [C′, D′], and [E′, F′], it may be determined that uplink rate ranges associated with the downlink rate ranges: [A′, B′], [C′, D′], and [E′, F′] are [A′ *k_a′, B′ *k_b′], [C′ *k_c′, D′ *k_d′], and [E′ *k_e′, F′ *k_f′].

In some implementations, the third ratio, the fourth ratio, the fifth ratio, and the sixth ratio may be integers or decimals.

In some implementations, the third ratio may be the same as or different from the fourth ratio. For example, the third ratio includes k_a, and the fourth ratio includes k_b, where k_a may be the same as or different from k_b.

Similarly, the fifth ratio may be the same as or different from the sixth ratio.

In some implementations, if the third ratio is the same as the fourth ratio, the first association information may include at least one of the third ratio and the fourth ratio. For example, the third ratio includes k_a, and the fourth ratio includes k_b. If k_a is the same as k_b, the first association information may include at least one of k_a and k_b.

Similarly, if the fifth ratio is the same as the sixth ratio, the first association information may include at least one of the fifth ratio and the sixth ratio.

In some implementations, the foregoing first association information may be defined by a protocol. For example, the protocol defines the uplink rate and the downlink rate of the first service in Table 1 to Table 6, or the range of the uplink rate and the range of the downlink rate of the first service.

In some implementations, at least one of the terminal device or the first network element has learned of the first association information.

In some implementations, that the terminal device has learned of the first association information may be understood as that the application layer of the terminal device has learned of the first association information.

In some implementations, at least one of the uplink rate or the downlink rate of the first service is associated with a wireless condition. In other words, at least one of the uplink rate or the downlink rate of the first service can be determined based on the wireless condition, that is, at least one of the uplink rate or the downlink rate of the first service that can be supported by the radio interface can be determined based on the wireless condition.

In some implementations, the wireless condition may be indicated by a radio resource management (RRM) measurement result. For example, the wireless condition may use one or more of the following indicators: a channel quality indicator (channel quality indicator, CQI); a signal-to-noise ratio (signal noise ratio, SNR); or a signal to interference plus noise ratio (signal to noise plus interference power ratio, SINR). For example, the SNR indicates the wireless condition, and the uplink rate of the first service is determined based on the SNR.

In some implementations, the first information includes one or more of the following: the downlink rate of the first service, the uplink rate of the first service; a first uplink rate; a first downlink rate; a first uplink rate range; or a first downlink rate range.

In some implementations, the first uplink rate is an uplink rate that is expected by the network device for the first service, and the first uplink rate is also referred to as a “target uplink rate”.

In some implementations, the uplink rate that is expected by the network device for the first service may be understood as the uplink rate that is determined by the network device for the first service.

In some implementations, the first uplink rate is a downlink rate that is expected by the network device for the first service, and the first downlink rate is also referred to as a “target downlink rate”.

In some implementations, the uplink rate that is expected by the network device for the first service may be understood as the downlink rate that is determined by the network device for the first service.

In some implementations, the first uplink rate range is a range of an uplink rate that is expected by the network device for the first service, and the first uplink rate range is also referred to as a “target uplink rate range”.

In some implementations, the range of the uplink rate that is expected by the network device for the first service may be understood as the range of the uplink rate that is determined by the network device for the first service.

In some implementations, the first uplink rate range is a range of a downlink rate that is expected by the network device for the first service, and the first downlink rate range is also referred to as a “target downlink rate range”.

In some implementations, the range of the downlink rate that is expected by the network device for the first service may be understood as the range of the downlink rate that is determined by the network device for the first service.

In some implementations, an occasion at which the network device transmits the first information to the terminal device and/or the first network element may be determined based on the wireless condition and/or a network congestion status. In other words, a rate adjustment procedure, initiated by the network device, of the first service is triggered based on the wireless condition and/or the network congestion status. For example, the first service is an XR service. In a transmission process of the XR service, if the wireless condition changes, for example, the wireless condition deteriorates, the network device may transmit the first information to the terminal device and/or the first network element, to reduce a rate of the XR service of the terminal device and free up a radio resource to transmit service data to another terminal device. In this case, the rate of the XR service of the terminal device needs to be reduced. After the wireless condition of the terminal device becomes better, the first information is then transmitted to improve the rate of the XR service of the terminal device. For another example, network congestion occurs. In this case, even if the wireless condition of the terminal device does not change obviously, the network device may transmit the first information to the terminal device and/or the first network element, to reduce the rate of the XR service of the terminal device. The network device then transmits the first information when being relieved from congestion, to improve the rate of the XR service of the terminal device.

In some implementations, the first information transmitted by the network device to the terminal device may be carried in an RRC message or an MAC CE.

In some implementations, an RRC message carrying the first information may be an RRC reconfiguration message.

In some implementations, a MAC CE carrying the first information may be a MAC CE in an existing protocol or a newly defined MAC CE. For example, the first information is carried in existing “Recommended bit rate MAC CE”.

In some implementations, if the first information includes the first uplink rate range and/or the first downlink rate range, and the MAC CE in the existing protocol is not supported, the MAC CE carrying the first information may be a newly defined MAC CE.

In some implementations, the newly defined MAC CE may be identified by using a logical channel identity (logical channel identity, LCID) or an extended logical channel identity (extended logical channel identity, eLCID).

In some implementations, after receiving the first information, the terminal device notifies the application layer of the first service.

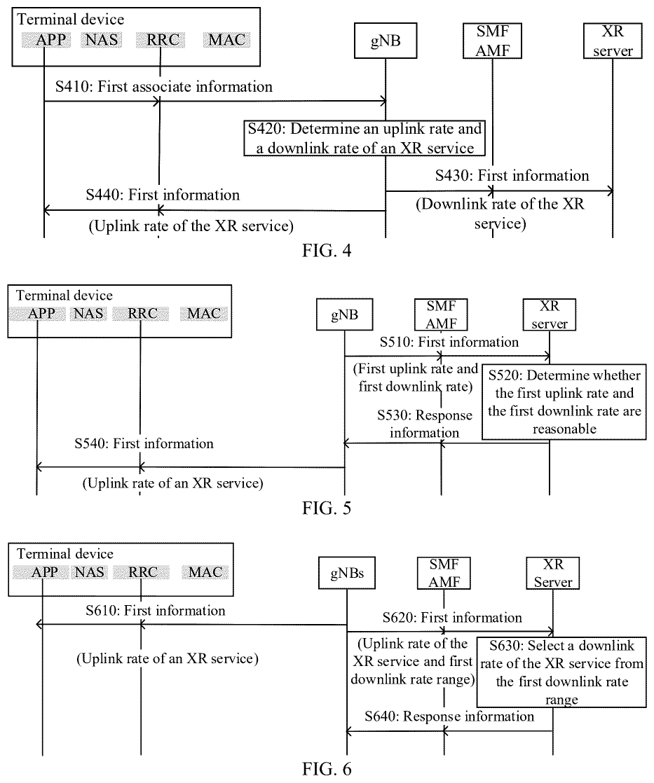

In some implementations, if the network device transmits the first information by using the RRC message, after receiving the first information, an RRC layer of the terminal device notifies the application layer of the terminal device. For example, with reference to FIG. 4, the network device transmits the first information to the terminal device by using the RRC message. After receiving the first information, the RRC layer of the terminal device notifies the application layer of the terminal device.

In some implementations, if the network device transmits the first information by using the MAC CE message, after receiving the first information, a MAC layer of the terminal device notifies the application layer of the terminal device. For example, the network device is a gNB, and the gNB transmits the first information to the terminal device by using the MAC CE. The MAC layer of the terminal device receives the first information, and notifies the application layer of the terminal device.

In some implementations, the network device is an access network device, and the access network device transmits the first information to the first network element by using a next generation (next generation, NG) interface message. In other words, the first information transmitted by the network device to the first network element is carried in the NG interface message.

In some implementations, that the access network device transmits the first information to the first network element by using the NG interface message may be understood as that the access network device notifies the first network element of the first information through the core network element by using the NG interface message.

In some implementations, the core network element may include an SMF and/or an AMF. For example, with reference to FIG. 4, the first service is an XR service, the access network device is a gNB, the core network element is an SMF and an AMF, and the first network element is an XR server. The gNB notifies the AMF of the first information by using the NG interface message, and then forwards the first information to the XR server by using the SMF.

It can be learned from the foregoing that an association relationship exists between the uplink rate and the downlink rate of the first service. When the uplink rate and the downlink rate of the first service are adjusted, this feature needs to be met. In a conventional solution, when rate adjustment is negotiated between application layers, application layers of both parties know the foregoing association relationship. Therefore, there is no problem. However, if the network device adjusts the uplink rate and the downlink rate of the first service in a manner of transmitting the first information, the network device does not know the association relationship between the uplink rate and the downlink rate of the first service, and a determined expected rate may not meet a requirement of the application layer, which reduces experience of the first service.

For this problem, to correlate the uplink rate and/or the downlink rate of the first service that are/is determined based on the first information, before the network device transmits the first information to the terminal device and/or the first network element, the network device may obtain the first association information. The following describes a solution in which the network device obtains the first association information from the terminal device or the first network element in Embodiment 1.

### Embodiment 1: The Network Device Obtains the First Association Information

In some implementations, the network device obtains the first association information from the terminal device or the first network element. Correspondingly, before receiving the first information, the terminal device or the first network element transmits the first association information to the network device.

In some implementations, the network device obtains the first association information from OAM.

In some implementations, a manner in which the network device obtains the first association information from the terminal device may be obtained by using an RRC message or by using a MAC CE.

In some implementations, if the network device obtains the first association information from the terminal device by using an RRC message, the RRC message may be UE Assistance information.

In some implementations, that the terminal device transmits the first association information to the network device by using the RRC message may be understood as that the application layer of the terminal device notifies the RRC layer of the terminal device of the first association information by using inter-layer primitives, and then the RRC layer of the terminal device transmits the first association information to the network device by using the RRC message.

In some implementations, if the network device obtains the first association information from the terminal device by using the MAC CE, the MAC CE may be a MAC CE in an existing protocol or a newly defined MAC CE.

In some implementations, a manner in which the network device obtains the first association information from the first network element may be obtaining the first association information from the first network element by using the core network element. For example, the first network element is an XR server, the network device is an access network device, and the core network element includes an SMF and an AMF. The XR server notifies the SMF, the SMF notifies the AMF, and the AMF notifies the access network device.

In some implementations, after obtaining the first association information, the network device determines the uplink rate and the downlink rate of the first service based on the first association information and the wireless condition. For example, the network device is a base station, and the first association information received by the base station is three groups of uplink rates and downlink rates in Table 1. The base station determines, based on a scheduling algorithm with reference to Table 1 and the wireless condition, that the uplink rate and the downlink rate of the first service are respectively A and B.

In some implementations, the network device transmits the first information to the terminal device and the first network element, where the first information includes the uplink rate and the downlink rate of the first service.

In some implementations, the first information transmitted by the network device to the terminal device may include the uplink rate and the downlink rate of the first service, or include only the uplink rate of the first service.

In some implementations, the first information transmitted by the network device to the first network element may include the uplink rate and the downlink rate of the first service, or include only the downlink rate of the first service.

In some implementations, after receiving the first information, the terminal device and the first network element each adjust a data transmission rate of a first service. For example, the first service is an XR service. After receiving the first information, the terminal device adjusts a rate of transmitting data of an XR service by the terminal device to an uplink rate, included in the first information, of the XR service. After receiving the first information, the first network element adjusts a rate of transmitting data of an XR service by the first network element to a downlink rate, included in the first information, of the XR service.

For ease of understanding, the following describes the solution in Embodiment 1 by using FIG. 4 as an example. Steps in FIG. 4 include step S410 to step S440.

It is assumed that the first service is an XR service, the network device is an access network device, the access network device transmits first information to the first network element through the core network element, the first network element is an XR server, the access network device is a gNB, and the core network element includes an SMF and an AMF.

In step S410, the terminal device transmits first association information to the gNB.

The application layer of the terminal device notifies the RRC layer of the terminal device of the first association information by using inter-layer primitives. The RRC layer of the terminal device transmits the first association information to the gNB by using an RRC message.

In step S420, the gNB determines an uplink rate and a downlink rate of the XR service.

The gNB determines the uplink rate and the downlink rate of the XR service based on the first association information and a wireless condition.

In step S430, the gNB transmits the first information to the XR server.

The gNB notifies the AMF of the first information by using an NG interface message, and then notifies the XR server of the first information through forwarding performed by the SMF. The first information includes the downlink rate of the XR service.

In step S440, the gNB transmits first information to the terminal device.

The gNB transmits the first information to the terminal device by using an RRC message. The RRC layer of the terminal device receives the first information, to notify the application layer of the terminal device. The first information includes the uplink rate of the XR service.

In the method in Embodiment 1, the network device needs to obtain the first association information, and an additional procedure needs to be introduced. In some implementations, the network device does not need to obtain the first association information, and only at least one of the terminal device or the first network element needs to learn of the first association information. When the network device considers that a rate of the first service needs to be adjusted, the network device transmits the first information to the terminal device and/or the first network element. The first information includes one or more of the following: a first uplink rate and/or a first downlink rate; a first uplink rate range and/or a first downlink rate range; or the uplink rate of the first service or the downlink rate of the first service. Because the first information may include a part or all of rates that are expected by the network device for the first service, or may include a single-side rate (such as the uplink rate or the downlink rate of the first service) that is of the first service and that is determined by the network device. After receiving the first information, at least one of the terminal device or the first network element that has learned of the first association information may determine, based on the first association information, the finally adjusted rate of the first service.

The following describes a solution in which the network device does not obtain the first association information in Embodiment 2.

### Embodiment 2: The Network Device does not Obtain the First Association Information

In some implementations, the network device does not obtain the first association information, but the network device learns that at least one of the terminal device or the first network element has learned of the first association information.

In some implementations, the network device learns, based on a predefined configuration or an operation administration and maintenance (operation administration and maintenance, OAM) configuration, that at least one of the terminal device or the first network element has learned of the first association information.

### Implementation 2-1: The First Information Includes the First Uplink Rate and/or the First Downlink Rate

In some implementations, at least one of the first uplink rate or the first downlink rate is determined by the network device based on a wireless condition. For example, the network device determines the first uplink rate and/or the first downlink rate based on the current wireless condition.

In some implementations, if the first information includes the first uplink rate and/or the first downlink rate, the terminal device or the first network element may determine, based on the foregoing association relationship, whether at least one of the first uplink rate or the first downlink rate is reasonable.

In some implementations, the terminal device or the first network element may determine, based on the association relationship indicated by the first association information, whether at least one of the first uplink rate or the first downlink rate is reasonable.

In some implementations, if the terminal device has learned of the first association information, whether at least one of the first uplink rate or the first downlink rate is reasonable is determined by the terminal device. In other words, if the network device learns that the terminal device has learned of the first association information, the network device transmits the first information to the terminal device. The first information includes the first uplink rate and/or the first downlink rate. The terminal device determines, based on the association relationship indicated by the first association information, whether at least one of the first uplink rate or the first downlink rate is reasonable.

In some implementations, if a first network element has learned of the first association information, whether at least one of the first uplink rate or the first downlink rate is reasonable is determined by the first network element. In other words, if the network device learns that the first network element has learned of the first association information, the network device transmits the first information to the first network element. The first information includes the first uplink rate and/or the first downlink rate. The first network element determines, based on the association relationship indicated by the first association information, whether at least one of the first uplink rate or the first downlink rate is reasonable.

In some implementations, if the terminal device and the first network element both have learned of the first association information, whether at least one of the first uplink rate or the first downlink rate is reasonable is determined by either of the terminal device and the first network element. In other words, if the network device learns that the terminal device and the first network element have learned of the first association information, the network device transmits the first information to at least one of the terminal device and the first network element. The first information includes the first uplink rate and/or the first downlink rate. The terminal device or the first network element determines, based on the association relationship indicated by the first association information, whether at least one of the first uplink rate or the first downlink rate is reasonable.

In some implementations, if the first network element has learned of the first association information, the network device transmits the first information to the first network element. The first information includes the first uplink rate and/or the first downlink rate. The first network element determines, based on the association relationship indicated by the first association information, whether the first uplink rate and the first downlink rate are reasonable.

In some implementations, if the terminal device has learned of the first association information, the network device transmits the first information to the terminal device. The first information includes the first uplink rate and/or the first downlink rate. The terminal device determines, based on the association relationship indicated by the first association information, whether the first uplink rate and the first downlink rate are reasonable.

In some implementations, if both the terminal device and the first network element have learned of the first association information, the network device transmits the first information to either of the terminal device and the first network element. The first information includes the first uplink rate and/or the first downlink rate. The terminal device or the first network element determines, based on the association relationship indicated by the first association information, whether the first uplink rate and the first downlink rate are reasonable.

In some implementations, if the first network element has learned of the first association information, the network device transmits the first information to the terminal device and the first network element. The first information transmitted by the network device to the terminal device includes the uplink rate of the first service. The first information transmitted by the network device to the first network element includes the uplink rate of the first service and the first downlink rate. The first network element determines, based on the association relationship indicated by the first association information, whether the first downlink rate is reasonable. In this manner, the terminal device makes little modification, which facilitates implementation.

In some implementations, if the terminal device or the first network element determines that at least one of the first uplink rate or the first downlink rate is unreasonable, the terminal device or the first network element determines, based on the first association information, at least one of the uplink rate or the downlink rate that is expected by the terminal device or the first network element for the first service.

In some implementations, at least one of the uplink rate or the downlink rate that is expected by the terminal device or the first network element for the first service may be understood as at least one of an uplink rate or a downlink rate that is suggested by the terminal device or the first network element for the first service. For example, the terminal device provides the suggested downlink rate of the first service based on a channel quality measurement result and/or the first association information.

In some implementations, if the terminal device has learned of the first association information, the network device transmits the first information to the terminal device and the first network element. The first information transmitted by the network device to the terminal device includes the first uplink rate and the downlink rate of the first service. The first information transmitted by the network device to the first network element includes the downlink rate of the first service. The terminal device determines, based on the association relationship indicated by the first association information, whether the first uplink rate is reasonable.

In some implementations, if both the terminal device and the first network element have learned of the first association information, the network device may transmit the rate, corresponding to either of the terminal device and the first network element, of the first service to either of the terminal device and the first network element, and transmit a rate, to be confirmed by the other of the terminal device and the first network element, of the first service to the other of the terminal device and the first network element. In other words, the first information transmitted by the network device to the terminal device includes the uplink rate of the first service, and the first information transmitted to the first network element includes the uplink rate of the first service and the first downlink rate. The first network element determines, based on the association relationship indicated by the first association information, whether the first downlink rate is reasonable. Alternatively, the first information transmitted by the network device to the terminal device includes the downlink rate of the first service and the first uplink rate, and the first information transmitted to the first network element includes the downlink rate of the first service. The terminal device determines, based on the association relationship indicated by the first association information, whether the first uplink rate is reasonable.

In some implementations, if the first information includes the first uplink rate and the first downlink rate, determining whether at least one of the first uplink rate or the first downlink rate is reasonable may be understood as follows: if the first uplink rate and the first downlink rate meet the association relationship, the first uplink rate and the first downlink rate are reasonable; or if the first uplink rate and the first downlink rate do not meet the association relationship, the first uplink rate and the first downlink rate are unreasonable. For example, for the first association information, reference may be made to the three groups of uplink rates and downlink rates in Table 1. If the first uplink rate and the first downlink rate that are included in the first information are respectively the same as an uplink rate and a downlink rate that are indicated by any index in Table 1 (for example, the first uplink rate is C, and the first downlink rate is C′), the first uplink rate and the first downlink rate are reasonable. If the first uplink rate and the first downlink rate that are included in the first information are not completely the same as an uplink rate and a downlink rate that are indicated by any index in Table 1 (for example, the first uplink rate is not C, and/or the first downlink rate is not C′), the first uplink rate and the first downlink rate are unreasonable. For another example, for the first association information, reference may be made to the three groups of uplink rate ranges and downlink rate ranges in Table 2. If the first uplink rate and the first downlink rate that are included in the first information are respectively within an uplink rate range and a downlink rate range that are indicated by any index in Table 2 (for example, the first uplink rate is within [C, D], and the first downlink rate is within [C′, D′]), the first uplink rate and the first downlink rate are reasonable. If the first uplink rate and the first downlink rate that are included in the first information are not respectively in an uplink rate range and a downlink rate range that are indicated by any index in Table 1 (for example, the first uplink rate is within [C, D], but the first downlink rate is not within [C′, D′]), the first uplink rate and the first downlink rate are unreasonable.

In some implementations, if the first uplink rate and the first downlink rate are reasonable, the first uplink rate is the uplink rate of the first service, and the first downlink rate is the downlink rate of the first service.

In some implementations, if the first uplink rate and the first downlink rate are unreasonable, the terminal device or the first network element determines an expected uplink rate and an expected downlink rate of the first service based on the first association information. For example, for the first association information, reference may be made to the three groups of uplink rates and downlink rates in Table 1. If the terminal device determines that the first uplink rate and the first downlink rate are unreasonable, one group of an uplink rate and a downlink rate from the three groups in Table 1 as the uplink rate and the downlink rate of the first service that are expected by the terminal device. Alternatively, a rate pair in which an uplink rate is the same as the first uplink rate or a downlink rate is the same as the first downlink rate is selected from Table 1, and the other rate is used as the other-side rate that is expected by the terminal device for the first service. In Table 1, if the uplink rate corresponding to an index value of 1 is the same as the first uplink rate, the downlink rate corresponding to the index value of 1 is selected as the downlink rate that is expected by the terminal device for the first service. For example, for the first association information, reference may be made to the three groups of uplink rate ranges and downlink rate ranges in Table 2. If the terminal device determines that the first uplink rate and the first downlink rate are unreasonable, one group of an uplink rate range and a downlink rate range is selected from the three groups in Table 2, and the uplink rate and the downlink rate of the first service that are expected by the terminal device are selected from the group of the uplink rate range and the downlink rate range. Alternatively, a rate range pair in which the first uplink rate is within an uplink rate range or the first downlink rate is within a downlink rate range is selected from Table 2, and the other-side rate that is expected by the terminal device for the first service is selected from the other rate range. If the first downlink rate is within the downlink rate range corresponding to the index value of 1 in Table 2, the uplink rate that is expected by the terminal device for the first service is selected from the uplink rate range corresponding to the index value of 1.

In some implementations, if the first information includes the first uplink rate, determining whether the first uplink rate is reasonable may be understood as follows: if the first uplink rate and the stored downlink rate of the first service meet the association relationship, the first uplink rate is reasonable; or if the first uplink rate and the stored downlink rate of the first service do not meet the association relationship, the first uplink rate is unreasonable. For example, for the first association information, reference may be made to the three groups of uplink rates and downlink rates in Table 1. If the first uplink rate and the stored downlink rate of the first service that are included in the first information are respectively the same as an uplink rate and a downlink rate that are indicated by any index in Table 1 (for example, the first uplink rate is C, and the stored downlink rate of the first service is C′), the first uplink rate is reasonable. If the first uplink rate and the stored downlink rate of the first service that are included in the first information are not completely the same as an uplink rate and a downlink rate that are indicated by any index in Table 1 (for example, the first uplink rate is not C, and/or the stored downlink rate of the first service is not C′), the first uplink rate is unreasonable. For another example, for the first association information, reference may be made to the three groups of uplink rate ranges and downlink rate ranges in Table 2. If the first uplink rate and the stored downlink rate of the first service that are included in the first information are respectively within an uplink rate range and a downlink rate range that are indicated by any index in Table 1 (for example, the first uplink rate is within [C, D], and the stored downlink rate of the first service is within [C′, D′]), the first uplink rate is reasonable. If the first uplink rate and the stored downlink rate of the first service that are included in the first information are not respectively in an uplink rate range and a downlink rate range that are indicated by any index in Table 1 (for example, the first uplink rate is within [C, D], but the stored downlink rate of the first service is not within [C′, D′]), the first uplink rate is unreasonable.

In some implementations, if the first uplink rate is reasonable, the first uplink rate is the uplink rate of the first service.

In some implementations, if the first uplink rate is unreasonable, the terminal device or the first network element determines the expected uplink rate of the first service based on the first association information. For example, for the first association information, reference may be made to the three groups of uplink rates and downlink rates in Table 1. If the terminal device determines that the first uplink rate is unreasonable, a rate pair in which a downlink rate is the same as the stored downlink rate of the first service is selected from Table 1, and the uplink rate in the rate pair is used as the uplink rate that is expected by the terminal device for the first service. For another example, for the first association information, reference may be made to the three groups of uplink rate ranges and downlink rate ranges in Table 2. If the terminal device determines that the first uplink rate is unreasonable, a rate range pair in which the stored downlink rate of the first service is within a downlink rate range is selected from the three groups in Table 2, and a rate is selected from the uplink rate range in the rate range pair as the uplink rate that is expected by the terminal device for the first service.

In some implementations, if the first information includes the first downlink rate, determining whether the first downlink rate is reasonable may be understood as follows: if the first downlink rate and the stored uplink rate of the first service meet the association relationship, the first downlink rate is reasonable; or if the first downlink rate and the stored uplink rate of the first service do not meet the association relationship, the first downlink rate is unreasonable. For example, for the first association information, reference may be made to the three groups of uplink rates and downlink rates in Table 1. If the first downlink rate and the stored uplink rate of the first service that are included in the first information are respectively the same as an uplink rate and a downlink rate that are indicated by any index in Table 1 (for example, the stored uplink rate of the first service is C, and the first downlink rate is C′), the first downlink rate is reasonable. If the first downlink rate and the stored uplink rate of the first service that are included in the first information are not completely the same as an uplink rate and a downlink rate that are indicated by any index in Table 1 (for example, the stored uplink rate of the first service is not C, and/or the first downlink rate is not C′), the first downlink rate is unreasonable. For another example, for the first association information, reference may be made to the three groups of uplink rate ranges and downlink rate ranges in Table 2. If the first downlink rate and the stored uplink rate of the first service that are included in the first information are respectively within an uplink rate range and a downlink rate range that are indicated by any index in Table 1 (for example, the stored uplink rate of the first service is within [C, D], and the first downlink rate is within [C′, D′]), the first downlink rate is reasonable. If the first downlink rate and the stored uplink rate of the first service that are included in the first information are not respectively in an uplink rate range and a downlink rate range that are indicated by any index in Table 1 (for example, the stored uplink rate of the first service is within [C, D], but the first downlink rate is not within [C′, D′]), the first downlink rate is unreasonable.

In some implementations, if the first downlink rate is reasonable, the first downlink rate is the downlink rate of the first service.

In some implementations, if the first downlink rate is unreasonable, the terminal device or the first network element determines the expected downlink rate of the first service based on the first association information. For example, for the first association information, reference may be made to the three groups of uplink rates and downlink rates in Table 1. If the terminal device determines that the first downlink rate is unreasonable, a rate pair in which an uplink rate is the same as the stored uplink rate of the first service is selected from Table 1, and the downlink rate in the rate pair is used as the downlink rate that is expected by the terminal device for the first service. For another example, for the first association information, reference may be made to the three groups of uplink rate ranges and downlink rate ranges in Table 2. If the terminal device determines that the first downlink rate is unreasonable, a rate range pair in which the stored uplink rate of the first service is within an uplink rate range is selected from the three groups in Table 2, and a rate is selected from the downlink rate range in the rate range pair as the downlink rate that is expected by the terminal device for the first service.

In some implementations, if the first information includes the uplink rate of the first service and the first downlink rate, determining whether the first downlink rate is reasonable may be understood as follows: if the uplink rate of the first service and the first downlink rate meet the association relationship, the first downlink rate is reasonable; or if the uplink rate of the first service and the first downlink rate do not meet the association relationship, the first downlink rate is unreasonable. For example, for the first association information, reference may be made to the three groups of uplink rates and downlink rates in Table 1. If the uplink rate of the first service and the first downlink rate that are included in the first information are respectively the same as an uplink rate and a downlink rate that are indicated by any index in Table 1 (for example, the uplink rate of the first service is C, and the first downlink rate is C′), the first downlink rate is reasonable. If the uplink rate of the first service and the first downlink rate that are included in the first information are not completely the same as an uplink rate and a downlink rate that are indicated by any index in Table 1 (for example, the uplink rate of the first service is not C, and/or the first downlink rate is not C′), the first downlink rate is unreasonable. For another example, for the first association information, reference may be made to the three groups of uplink rate ranges and downlink rate ranges in Table 2. If the uplink rate of the first service and the first downlink rate that are included in the first information are respectively within an uplink rate range and a downlink rate range that are indicated by any index in Table 1 (for example, the uplink rate of the first service is within [C, D], and the first downlink rate is within [C′, D′]), the first downlink rate is reasonable. If the uplink rate of the first service and the first downlink rate that are included in the first information are not respectively in an uplink rate range and a downlink rate range that are indicated by any index in Table 1 (for example, the uplink rate of the first service is within [C, D], but the first downlink rate is not within [C′, D′]), the first downlink rate is unreasonable.

In some implementations, if the first downlink rate is reasonable, the first downlink rate is the downlink rate of the first service.

In some implementations, if the first downlink rate is unreasonable, the terminal device or the first network element determines the expected downlink rate of the first service based on the first association information. For example, for the first association information, reference may be made to the three groups of uplink rates and downlink rates in Table 1. If the terminal device determines that the first downlink rate is unreasonable, a rate pair in which an uplink rate is the same as the uplink rate of the first service is selected from Table 1, and the downlink rate in the rate pair is used as the downlink rate that is expected by the terminal device for the first service. For another example, for the first association information, reference may be made to the three groups of uplink rate ranges and downlink rate ranges in Table 2. If the terminal device determines that the first downlink rate is unreasonable, a rate range pair in which the uplink rate of the first service is within an uplink rate range is selected from the three groups in Table 2, and a rate is selected from the downlink rate range in the rate range pair as the downlink rate that is expected by the terminal device for the first service.

In some implementations, if the first information includes the downlink rate of the first service and the first uplink rate, determining whether the first uplink rate is reasonable may be understood as follows: if the downlink rate of the first service and the first uplink rate meet the association relationship, the first uplink rate is reasonable; or if the downlink rate of the first service and the first uplink rate do not meet the association relationship, the first uplink rate is unreasonable. For example, for the first association information, reference may be made to the three groups of uplink rates and downlink rates in Table 1. If the first uplink rate and the downlink rate of the first service that are included in the first information are respectively the same as an uplink rate and a downlink rate that are indicated by any index in Table 1 (for example, the first uplink rate is C, and the downlink rate of the first service is C′), the first uplink rate is reasonable. If the first uplink rate and the downlink rate of the first service that are included in the first information are not completely the same as an uplink rate and a downlink rate that are indicated by any index in Table 1 (for example, the first uplink rate is not C, and/or the downlink rate of the first service is not C′), the first uplink rate is unreasonable. For another example, for the first association information, reference may be made to the three groups of uplink rate ranges and downlink rate ranges in Table 2. If the first uplink rate and the downlink rate of the first service that are included in the first information are respectively within an uplink rate range and a downlink rate range that are indicated by any index in Table 1 (for example, the first uplink rate is within [C, D], and the downlink rate of the first service is within [C′, D′]), the first uplink rate is reasonable. If the first uplink rate and the downlink rate of the first service that are included in the first information are not respectively in an uplink rate range and a downlink rate range that are indicated by any index in Table 1 (for example, the first uplink rate is within [C, D], but the downlink rate of the first service is not within [C′, D′]), the first uplink rate is unreasonable.

In some implementations, if the first uplink rate is reasonable, the first uplink rate is the uplink rate of the first service.

In some implementations, if the first uplink rate is unreasonable, the terminal device or the first network element determines the expected uplink rate of the first service based on the first association information. For example, for the first association information, reference may be made to the three groups of uplink rates and downlink rates in Table 1. If the terminal device determines that the first uplink rate is unreasonable, a rate pair in which a downlink rate is the same as the downlink rate of the first service is selected from Table 1, and the uplink rate in the rate pair is used as the uplink rate that is expected by the terminal device for the first service. For another example, for the first association information, reference may be made to the three groups of uplink rate ranges and downlink rate ranges in Table 2. If the terminal device determines that the first uplink rate is unreasonable, a rate range pair in which the downlink rate of the first service is within a downlink rate range is selected from the three groups in Table 2, and a rate is selected from the uplink rate range in the rate range pair as the uplink rate that is expected by the terminal device for the first service.

In some implementations, after the terminal device or the network device determines whether at least one of the first uplink rate or the first downlink rate is reasonable, the terminal device or the first network element transmits response information to the network device.

In some implementations, the response information is used to indicate one or more of the following: whether the first uplink rate is the uplink rate of the first service; whether the first downlink rate is the downlink rate of the first service; at least one of the uplink rate or the downlink rate that is expected by the terminal device or the first network element for the first service; or that the network device re-initiates rate adjustment of the first service.

In some implementations, if the terminal device or the first network element determines that the first uplink rate is reasonable, the response information indicates that the first uplink rate is the uplink rate of the first service.

In some implementations, if the terminal device or the first network element determines that the first uplink rate is unreasonable, the response information indicates that the first uplink rate is not the uplink rate of the first service.

In some implementations, if the terminal device or the first network element determines that the first uplink rate is unreasonable, the response information indicates the uplink rate that is expected by the terminal device or the first network element for the first service.

In some implementations, if the terminal device or the first network element determines that the first downlink rate is reasonable, the response information indicates that the first downlink rate is the downlink rate of the first service.

In some implementations, if the terminal device or the first network element determines that the first downlink rate is unreasonable, the response information indicates that the first downlink rate is not the downlink rate of the first service.

In some implementations, if the terminal device or the first network element determines that the first downlink rate is unreasonable, the response information indicates the downlink rate that is expected by the terminal device or the first network element for the first service.

In some implementations, if the terminal device or the first network element determines that the first uplink rate and the first downlink rate are reasonable, the response information indicates that the first uplink rate is the uplink rate of the first service, and the first downlink rate is the downlink rate of the first service.

In some implementations, if the terminal device or the first network element determines that the first uplink rate and the first downlink rate are unreasonable, the response information indicates that the first uplink rate is not the uplink rate of the first service, and the first downlink rate is not the downlink rate of the first service.

In some implementations, if the terminal device or the first network element determines that the first uplink rate and the first downlink rate are unreasonable, the response information indicates the uplink rate and the downlink rate that are expected by the terminal device or the first network element for the first service.

In some implementations, if the terminal device or the first network element determines that at least one of the first uplink rate or the first downlink rate is unreasonable, the response information is further used to indicate that the network device re-initiates rate adjustment of the first service.

In some implementations, the response information transmitted by the terminal device to the network device is carried in a MAC CE or an RRC message.

In some implementations, the response information transmitted by the first network element to the network device is carried in an NG interface message.

It should be noted that a manner of transmitting the first information is also applicable to the response information. For details, reference may be made to the foregoing description of the manner of transmitting the first information. Details are not described herein again.

In some implementations, if the first information transmitted by the network device to the first network element includes the first uplink rate and/or the first downlink rate, and the response information indicates that the first uplink rate is the uplink rate of the first service, after receiving the response information, the network device transmits the first information to the terminal device if the uplink rate, indicated by the response information, of the first service is different from a current uplink rate of the first service. The first information includes the uplink rate of the first service. The network device does not transmit the first information to the terminal device if the uplink rate, indicated by the response information, of the first service is the same as a current uplink rate of the first service. The network device first notifies the first network element of the first information, and the terminal device does not need the known first association information, which facilitates reduction of an information procedure of air interface transmission.

In some implementations, if the first information transmitted by the network device to the first network element includes the first uplink rate and/or the first downlink rate, and the response information indicates the uplink rate that is expected by the first network element for the first service, after receiving the response information, the network device transmits the first information to the terminal device if the uplink rate that is expected by the first network element for the first service and indicated by the response information is different from the current uplink rate of the first service and the network device accepts the uplink rate that is expected by the first network element for the first service. The first information includes the uplink rate of the first service. The uplink rate of the first service is the uplink rate that is expected by the first network element for the first service. The network device does not transmit the first information to the terminal device if the uplink rate that is expected by the first network element for the first service and indicated by the response information is the same as the current uplink rate of the first service.

In some implementations, if the first information transmitted by the network device to the terminal device includes the first uplink rate and/or the first downlink rate, and the response information indicates that the first downlink rate is the downlink rate of the first service, after receiving the response information, the network device transmits the first information to the first network element if the downlink rate, indicated by the response information, of the first service is different from a current downlink rate of the first service. The first information includes the downlink rate of the first service. The network device does not transmit the first information to the first network element if the downlink rate, indicated by the response information, of the first service is the same as a current downlink rate of the first service. The network device first notifies the terminal device of the first information. Because air interface information exchange is fast and convenient, the uplink rate of the first service of the terminal device may be quickly adjusted, which facilitates quick alleviation of congestion when network congestion occurs.

In some implementations, if the first information transmitted by the network device to the terminal device includes the first uplink rate and/or the first downlink rate, and the response information indicates the downlink rate that is expected by the terminal device for the first service, after receiving the response information, the network device transmits the first information to the first network element if the downlink rate that is expected by the terminal device for the first service and indicated by the response information is different from the current downlink rate of the first service and the network device accepts the downlink rate that is expected by the terminal device for the first service. The first information includes the downlink rate of the first service. The downlink rate of the first service is the downlink rate that is expected by the terminal device for the first service. The network device does not transmit the first information to the first network element if the downlink rate that is expected by the terminal device for the first service and indicated by the response information is the same as the current downlink rate of the first service.

In some implementations, if the response information indicates that the network device re-initiates rate adjustment of the first service, after receiving the response information, the network device may re-initiate a new round of rate adjustment of the first service, to determine a reasonable uplink rate and/or a reasonable downlink rate of the first service.

For ease of understanding, the following describes the solution in Implementation 2-1 with reference to FIG. 5 by using an example in which the network device learns that the first network element has learned of the first association information. FIG. 5 includes steps S510 and S540.

It is assumed that the first service is an XR service, the network device is an access network device, the access network device transmits first information to the first network element through the core network element, the first network element is an XR server, the access network device is a gNB, and the core network element includes an SMF and an AMF.

In step S510, the gNB transmits the first information to the XR server.

The gNB notifies the AMF of the first information by using an NG interface message, and then notifies the XR server of the first information through forwarding performed by the SMF. The first information includes a first uplink rate and a first downlink rate.

In step S520, the XR server determines whether the first uplink rate and the first downlink rate are reasonable.

The XR server determines, based on first association information, whether the first uplink rate and the first downlink rate are reasonable. Specifically, if the first uplink rate and the first downlink rate meet an association relationship indicated by the first association information, the first uplink rate and the first downlink rate are reasonable, the first uplink rate is an uplink rate of the XR service, and the first downlink rate is a downlink rate of the XR service.

In step S530, the XR server transmits response information to the gNB.

The response information transmitted by the XR server to the gNB indicates that the first uplink rate is the uplink rate of the XR service and the first downlink rate is the downlink rate of the XR service.

In step S540, the gNB transmits first information to the terminal device.

The gNB receives the response information and determines the uplink rate of the XR service. The gNB transmits the first information to the terminal device by using an RRC message. The RRC layer of the terminal device receives the first information, to notify the application layer of the terminal device. The first information includes the uplink rate of the XR service.

### Implementation 2-2: The First Information Includes the First Uplink Rate Range and/or the First Downlink Rate Range

In some implementations, if the first information includes the first uplink rate range and/or the first downlink rate range, the terminal device or the first network element selects the uplink rate and/or the downlink rate of the first service from the first uplink rate range and/or the first downlink rate range based on the association relationship.

In some implementations, if the first network element has learned of the first association information, the network device transmits the first information to the first network element. The first information includes the first uplink rate range and/or the first downlink rate range. The first network element selects the uplink rate and/or the downlink rate of the first service from the first uplink rate range and/or the first downlink rate range based on the association relationship indicated by the first association information.

In some implementations, if the terminal device has learned of the first association information, the network device transmits the first information to the terminal device. The first information includes the first uplink rate range and/or the first downlink rate range. The terminal device selects the uplink rate and/or the downlink rate of the first service from the first uplink rate range and/or the first downlink rate range based on the association relationship indicated by the first association information.

In some implementations, if both the terminal device and the first network element have learned of the first association information, the network device transmits the first information to either of the terminal device and the first network element. The first information includes the first uplink rate range and/or the first downlink rate range. The terminal device or the first network element selects the uplink rate and/or the downlink rate of the first service from the first uplink rate range and/or the first downlink rate range based on the association relationship indicated by the first association information.

In some implementations, if the first network element has learned of the first association information, the network device transmits the first information to the terminal device and the first network element. The first information transmitted by the network device to the terminal device includes the uplink rate of the first service. The first information transmitted by the network device to the first network element includes the uplink rate of the first service and the first downlink rate range. The first network element selects the downlink rate of the first service from the first downlink rate range based on the association relationship indicated by the first association information.

In some implementations, if the terminal device has learned of the first association information, the network device transmits the first information to the terminal device and the first network element. The first information transmitted by the network device to the terminal device includes the first uplink rate range and the downlink rate of the first service. The first information transmitted by the network device to the first network element includes the downlink rate of the first service. The terminal device selects the uplink rate of the first service from the first uplink rate range based on the association relationship indicated by the first association information.

In some implementations, if both the terminal device and the first network element have learned of the first association information, the network device may transmit the rate, corresponding to either of the terminal device and the first network element, of the first service to either of the terminal device and the first network element, and transmit a rate range, to be confirmed by the other of the terminal device and the first network element, of the first service to the other of the terminal device and the first network element. In other words, the first information transmitted by the network device to the terminal device includes the uplink rate of the first service, and the first information transmitted to the first network element includes the uplink rate of the first service and the first downlink rate range. The first network element selects the downlink rate of the first service from the first downlink rate range based on the association relationship indicated by the first association information. Alternatively, the first information transmitted by the network device to the terminal device includes the downlink rate of the first service and the first uplink rate range, and the first information transmitted to the first network element includes the downlink rate of the first service. The terminal device selects the uplink rate of the first service from the first uplink rate range based on the association relationship indicated by the first association information.

In some implementations, if the first information includes the first uplink rate range and the first downlink rate range, the terminal device or the first network element selects the uplink rate and the downlink rate of the first service from the first uplink rate range and the first downlink rate range based on the association relationship.

In some implementations, selecting the uplink rate and the downlink rate of the first service from the first uplink rate range and the first downlink rate range based on the association relationship may be understood as: selecting, from the first uplink rate range and the first downlink rate range, the uplink rate and the downlink rate of the first service that meet the association relationship indicated by the first association information.

In some implementations, if the first association information includes the uplink rate and/or the downlink rate, selecting, from the first uplink rate range and the first downlink rate range, the uplink rate and the downlink rate of the first service that meet the association relationship indicated by the first association information may be understood as: selecting, as the uplink rate and the downlink rate of the first service from a plurality of groups of uplink rates and downlink rates indicated by the first association information, a rate pair in which an uplink rate and a downlink rate are respectively in the first uplink rate range and the first downlink rate range. For example, the first association information includes the uplink rate and the first ratio. For the first association information, reference may be made to the three groups of uplink rates and first ratios in Table 3. Table 3 shows the three groups of uplink rates and downlink rates. A rate pair in which an uplink rate and a downlink rate both are in the first uplink rate range and the first downlink rate range is selected as the uplink rate and the downlink rate of the first service from the three groups of uplink rates and downlink rates.

In some implementations, if the first association information includes the uplink rate range and/or the downlink rate range, selecting, from the first uplink rate range and the first downlink rate range, the uplink rate and the downlink rate of the first service that meet the association relationship indicated by the first association information may be understood as: selecting the uplink rate and the downlink rate of the first service from an intersection set between the plurality of groups of uplink rate ranges and downlink rate ranges indicated by the first association information, and the first uplink rate range and the first downlink rate range. For example, the first association information is the three groups of uplink rate ranges and downlink rate ranges in Table 2. The uplink rate and the downlink rate of the first service are selected from an intersection set between the three groups of uplink rate ranges and downlink rate ranges, and the first uplink rate range and the first downlink rate range.

In some implementations, if the first information includes the first downlink rate range, and the first information further includes the uplink rate of the first service, that the terminal device selects the downlink rate of the first service from the first downlink rate range based on the association relationship may be understood as follows: if the first information includes the uplink rate of the first service and the first downlink rate range, the terminal device selects, from the first downlink rate range, the downlink rate of the first service that meets the association relationship with the uplink rate of the first service.

In some implementations, if the first association information includes the uplink rate and/or the downlink rate, selecting, from the first downlink rate range, the downlink rate of the first service that meets the association relationship with the uplink rate of the first service may be understood as: from the plurality of groups of uplink rates and downlink rates indicated by the first association information, selecting a rate pair in which an uplink rate is the same as the uplink rate of the first service and a downlink rate is within the first downlink rate range, and using the downlink rate in the rate pair as the downlink rate of the first service. For example, the first association information includes the uplink rate and the first ratio. For the first association information, reference may be made to Table 3. Table 3 indicates the three groups of uplink rates and downlink rates. From the three groups of uplink rates and downlink rates, a rate pair in which an uplink rate is the same as the uplink rate of the first service and a downlink rate is within the first downlink rate range is selected, and the downlink rate in the rate pair is used as the downlink rate of the first service.

In some implementations, if the first association information includes the uplink rate range and/or the downlink rate range, selecting, from the first downlink rate range, the downlink rate of the first service that meets the association relationship with the uplink rate of the first service may be understood as: from the plurality of groups of uplink rate ranges and downlink rate ranges indicated by the first association information, selecting a rate range pair in which the uplink rate of the first service is within an uplink rate range and an intersection set exits between a downlink rate range and the first downlink rate range, and selecting the downlink rate of the first service from the intersection set between the downlink rate range and the first downlink rate range. For example, for the first association information, reference may be made to Table 2. Table 2 indicates the three groups of uplink rate ranges and downlink rate ranges. From the three groups of uplink rate ranges and downlink rate ranges, a rate range pair in which the uplink rate of the first service is within an uplink rate range and an intersection set exists between a downlink rate range and the first downlink rate range is selected, and the downlink rate of the first service is selected from the intersection set between the downlink rate range in the rate range pair and the first downlink rate range.

In some implementations, if the first information includes the first uplink rate range, and the first information further includes the downlink rate of the first service, that the first network element selects the uplink rate of the first service from the first uplink rate range based on the association relationship may be understood as follows: if the first information includes the downlink rate of the first service and the first uplink rate range, the first network element selects, from the first uplink rate range, the uplink rate of the first service that meets the association relationship with the downlink rate of the first service.

In some implementations, if the first association information includes the uplink rate and/or the downlink rate, selecting, from the first uplink rate range, the uplink rate of the first service that meets the association relationship with the downlink rate of the first service may be understood as: from the plurality of groups of uplink rates and downlink rates indicated by the first association information, selecting a rate pair in which a downlink rate is the same as the downlink rate of the first service and an uplink rate is within the first uplink rate range, and using the uplink rate in the rate pair as the uplink rate of the first service. For example, the first association information includes the uplink rate and the first ratio. For the first association information, reference may be made to Table 3. Table 3 indicates the three groups of uplink rates and downlink rates. From the three groups of uplink rates and downlink rates, a rate pair in which a downlink rate is the same as the downlink rate of the first service and an uplink rate is within the first uplink rate range is selected, and the uplink rate in the rate pair is used as the uplink rate of the first service.

In some implementations, if the first association information includes the uplink rate range and/or the downlink rate range, selecting, from the first uplink rate range, the uplink rate of the first service that meets the association relationship with the downlink rate of the first service may be understood as: from the plurality of groups of uplink rate ranges and downlink rate ranges indicated by the first association information, selecting a rate range pair in which the downlink rate of the first service is within a downlink rate range and an intersection set exits between an uplink rate range and the first uplink rate range, and selecting the uplink rate of the first service from the intersection set between the uplink rate range and the first uplink rate range. For example, for the first association information, reference may be made to Table 2. Table 2 indicates the three groups of uplink rate ranges and downlink rate ranges. From the three groups of uplink rate ranges and downlink rate ranges, a rate range pair in which the downlink rate of the first service is within a downlink rate range and an intersection set exists between an uplink rate range and the first uplink rate range is selected, and the uplink rate of the first service is selected from the intersection set between the uplink rate range in the rate range pair and the first uplink rate range.

In some implementations, if the first information includes the first uplink rate range, that the terminal device or the first network element selects the uplink rate of the first service from the first uplink rate range based on the association relationship may be understood as follows: the terminal device or the first network element selects, from the first uplink rate range, the uplink rate of the first service that meets the association relationship indicated by the first association information with the stored downlink rate of the first service.

In some implementations, if the first association information includes the uplink rate and/or the downlink rate, selecting, from the first uplink rate range, the uplink rate of the first service that meets the association relationship indicated by the first association information with the stored downlink rate of the first service may be understood as: from the plurality of groups of uplink rates and downlink rates indicated by the first association information, selecting a rate pair in which an uplink rate is within the first uplink rate range and a downlink rate is the same as the stored downlink rate of the first service, and using the uplink rate in the rate pair as the uplink rate of the first service. For example, the first association information includes the uplink rate and the first ratio. For the first association information, reference may be made to the three groups of uplink rates and first ratios in Table 3. Table 3 indicates the three groups of uplink rates and downlink rates. From the three groups of uplink rates and downlink rates, a rate pair in which an uplink rate is within the first uplink rate range and a downlink rate is the same as the stored downlink rate of the first service is selected, and the uplink rate in the rate pair is used as the uplink rate of the first service.

In some implementations, if the first association information includes the uplink rate range and/or the downlink rate range, selecting, from the first uplink rate range, the uplink rate of the first service that meets the association relationship indicated by the first association information with the downlink rate of the first service may be understood as: from the plurality of groups of uplink rate ranges and downlink rate ranges indicated by the first association information, selecting a rate range pair in which the stored downlink rate of the first service is within a downlink rate range and an intersection set exits between an uplink rate range and the first uplink rate range, and selecting the uplink rate of the first service from the intersection set between the uplink rate range and the first uplink rate range. For example, for the first association information, reference may be made to the three groups of uplink rate ranges and downlink rate ranges in Table 2. From the three groups of uplink rate ranges and downlink rate ranges, a rate range pair in which the stored downlink rate of the first service is within a downlink rate range and an intersection set exists between an uplink rate range and the first uplink rate range is selected, and the uplink rate of the first service is selected from the intersection set between the uplink rate range in the rate range pair and the first uplink rate range.

In some implementations, if the first information includes the first downlink rate range, that the terminal device or the first network element selects the downlink rate of the first service from the first downlink rate range based on the association relationship may be understood as follows: the terminal device or the first network element selects, from the first downlink rate range, the downlink rate of the first service that meets the association relationship indicated by the first association information with the stored uplink rate of the first service.

In some implementations, if the first association information includes the uplink rate and/or the downlink rate, selecting, from the first downlink rate range, the downlink rate of the first service that meets the association relationship indicated by the first association information with the stored uplink rate of the first service may be understood as: from the plurality of groups of uplink rates and downlink rates indicated by the first association information, selecting a rate pair in which a downlink rate is within the first downlink rate range and an uplink rate is the same as the stored uplink rate of the first service, and using the downlink rate in the rate pair as the downlink rate of the first service. For example, the first association information includes the uplink rate and the first ratio. For the first association information, reference may be made to the three groups of uplink rates and first ratios in Table 3. Table 3 indicates the three groups of uplink rates and downlink rates. From the three groups of uplink rates and downlink rates, a rate pair in which a downlink rate is within the first downlink rate range and an uplink rate is the same as the stored uplink rate of the first service is selected, and the downlink rate in the rate pair is used as the downlink rate of the first service.

In some implementations, if the first association information includes the uplink rate range and/or the downlink rate range, selecting, from the first downlink rate range, the downlink rate of the first service that meets the association relationship indicated by the first association information with the stored uplink rate of the first service may be understood as: from the plurality of groups of uplink rate ranges and downlink rate ranges indicated by the first association information, selecting a rate range pair in which the stored uplink rate of the first service is within an uplink rate range and an intersection set exits between a downlink rate range and the first downlink rate range, and selecting the downlink rate of the first service from the intersection set between the downlink rate range and the first downlink rate range. For example, for the first association information, reference may be made to the three groups of uplink rate ranges and downlink rate ranges in Table 2. From the three groups of uplink rate ranges and downlink rate ranges, a rate range pair in which the stored uplink rate of the first service is within an uplink rate range and an intersection set exists between a downlink rate range and the first downlink rate range is selected, and the downlink rate of the first service is selected from the intersection set between the downlink rate range in the rate range pair and the first downlink rate range.

In some implementations, if the terminal device or the first network element has selected, from the first uplink rate range and the first downlink rate range, the uplink rate and the downlink rate of the first service that meet the association relationship, the terminal device or the first network element may transmit response information to the network device, where the response information is used to indicate the uplink rate and the downlink rate of the first service.

In some implementations, if the terminal device or the first network element has not selected, from the first uplink rate range and the first downlink rate range, the uplink rate and the downlink rate of the first service that meet the association relationship, the terminal device or the first network element may transmit response information to the network device, where the response information is used to indicate that the network device re-initiates rate adjustment of the first service.

In some implementations, if the terminal device or the first network element has not selected, from the first uplink rate range and the first downlink rate range, the uplink rate and the downlink rate of the first service that meet the association relationship, the terminal device or the first network element determines, based on the first association information, an uplink rate and a downlink rate that are expected by the terminal device or the first network element for the first service, and transmits response information to the network device, where the response information indicates the uplink rate and the downlink rate that are expected by the terminal device or the first network element for the first service. For example, for the first association information, reference may be made to the three groups of uplink rates and downlink rates in Table 1. If the terminal device has not selected the uplink rate and the downlink rate of the first service that meet the association relationship, a group of an uplink rate and a downlink rate in the three groups in Table 1 is selected as the uplink rate and downlink rate that are expected by the terminal device for the first service. Alternatively, a rate pair in which an uplink rate is within the first uplink rate range or a downlink rate is within the first downlink rate range is selected from Table 1, and the uplink rate and the downlink rate in the rate pair are used as the uplink rate and the downlink rate that are expected by the terminal device for the first service. For another example, for the first association information, reference may be made to the three groups of uplink rate ranges and downlink rate ranges in Table 2. If the terminal device has not selected the uplink rate and the downlink rate of the first service that meet the association relationship, a group of an uplink rate range and a downlink rate range in the three groups in Table 2 is selected as the uplink rate and downlink rate that are expected by the terminal device for the first service. Alternatively, a rate range pair in which an intersection set exists between an uplink rate range and the first uplink rate range or an intersection set exists between a downlink rate range and the first downlink rate range is selected from Table 2, one-side rate that is expected by the terminal device for the first service is selected from the intersection set between the ranges, and the other-side rate that is expected by the terminal device for the first service is selected from the other rate range in the rate range pair. If an intersection set exists between the first downlink rate range and the downlink rate range corresponding to an index value of 1 in Table 2, the downlink rate that is expected by the terminal device for the first service is selected from an intersection set between the downlink rate range corresponding to the index value of 1 and the first downlink rate range, and the uplink rate that is expected by the terminal device for the first service is selected from the uplink rate range in the rate range pair.

In some implementations, if the terminal device or the first network element has selected, from the first downlink rate range, the downlink rate of the first service that meets the association relationship with the uplink rate of the first service, the terminal device or the first network element transmits response information to the network device, where the response information is used to indicate the downlink rate of the first service.

In some implementations, if the terminal device or the first network element has not selected, from the first downlink rate range, the downlink rate of the first service that meets the association relationship with the uplink rate of the first service, the terminal device or the first network element transmits response information to the network device, where the response information is used to indicate that the network device re-initiates rate adjustment of the first service.

In some implementations, if the terminal device or the first network element has not selected, from the first downlink rate range, the downlink rate of the first service that meets the association relationship with the uplink rate of the first service, the terminal device or the first network element determines, based on the first association information, a downlink rate that is expected by the terminal device or the first network element for the first service, and transmits response information to the network device, where the response information is used to indicate the downlink rate that is expected by the terminal device or the first network element for the first service. For example, for the first association information, reference may be made to the three groups of uplink rates and downlink rates in Table 1. If the terminal device has not selected the downlink rate of the first service that meets the association relationship with the uplink rate of the first service, a rate pair in which an uplink rate is the same as the uplink rate of the first service is selected from Table 1, and the downlink rate in the rate pair is used as the downlink rate that is expected by the terminal device for the first service. For another example, for the first association information, reference may be made to the three groups of uplink rate ranges and downlink rate ranges in Table 2. If the terminal device has not selected the downlink rate of the first service that meets the association relationship with the uplink rate of the first service, a rate range pair in which the uplink rate of the first service is within an uplink rate range is selected from the three groups in Table 2, and a rate is selected from the downlink rate range in the rate range pair as the downlink rate that is expected by the terminal device for the first service.

In some implementations, if the terminal device or the first network element has selected, from the first uplink rate range, the uplink rate of the first service that meets the association relationship with the downlink rate of the first service, the terminal device or the first network element transmits response information to the network device, where the response information is used to indicate the uplink rate of the first service.

In some implementations, if the terminal device or the first network element has not selected, from the first uplink rate range, the uplink rate of the first service that meets the association relationship with the downlink rate of the first service, the terminal device or the first network element transmits response information to the network device, where the response information is used to indicate that the network device re-initiates rate adjustment of the first service.

In some implementations, if the terminal device or the first network element has not selected, from the first uplink rate range, the uplink rate of the first service that meets the association relationship with the downlink rate of the first service, the terminal device or the first network element determines, based on the first association information, an uplink rate that is expected by the terminal device or the first network element for the first service, and transmits response information to the network device, where the response information is used to indicate the uplink rate that is expected by the terminal device or the first network element for the first service. For example, for the first association information, reference may be made to the three groups of uplink rates and downlink rates in Table 1. If the terminal device has not selected the uplink rate of the first service that meets the association relationship with the downlink rate of the first service, a rate pair in which a downlink rate is the same as the downlink rate of the first service is selected from Table 1, and the uplink rate in the rate pair is used as the uplink rate that is expected by the terminal device for the first service. For another example, for the first association information, reference may be made to the three groups of uplink rate ranges and downlink rate ranges in Table 2. If the terminal device has not selected the uplink rate of the first service that meets the association relationship with the downlink rate of the first service, a rate range pair in which the downlink rate of the first service is within a downlink rate range is selected from the three groups in Table 2, and a rate is selected from the uplink rate range in the rate range pair as the uplink rate that is expected by the terminal device for the first service.

In some implementations, if the terminal device or the first network element has selected, from the first downlink rate range, the downlink rate of the first service that meets the association relationship with the stored uplink rate of the first service, the terminal device or the first network element transmits response information to the network device, where the response information is used to indicate the downlink rate of the first service.

In some implementations, if the terminal device or the first network element has not selected, from the first downlink rate range, the downlink rate of the first service that meets the association relationship with the stored uplink rate of the first service, the terminal device or the first network element transmits response information to the network device, where the response information is used to indicate that the network device re-initiates rate adjustment of the first service.

In some implementations, if the terminal device or the first network element has not selected, from the first downlink rate range, the downlink rate of the first service that meets the association relationship with the stored uplink rate of the first service, the terminal device or the first network element determines, based on the first association information, a downlink rate that is expected by the terminal device or the first network element for the first service, and transmits response information to the network device, where the response information is used to indicate the downlink rate that is expected by the terminal device or the first network element for the first service. For example, for the first association information, reference may be made to the three groups of uplink rates and downlink rates in Table 1. If the terminal device has not selected the downlink rate of the first service that meets the association relationship with the stored uplink rate of the first service, a rate pair in which an uplink rate is the same as the stored uplink rate of the first service is selected from Table 1, and the downlink rate in the rate pair is used as the downlink rate that is expected by the terminal device for the first service. For another example, for the first association information, reference may be made to the three groups of uplink rate ranges and downlink rate ranges in Table 2. If the terminal device has not selected the downlink rate of the first service that meets the association relationship with the stored uplink rate of the first service, a rate range pair in which the stored uplink rate of the first service is within an uplink rate range is selected from the three groups in Table 2, and a rate is selected from the downlink rate range in the rate range pair as the downlink rate that is expected by the terminal device for the first service.

In some implementations, if the terminal device or the first network element has selected, from the first uplink rate range, the uplink rate of the first service that meets the association relationship with the stored downlink rate of the first service, the terminal device or the first network element transmits response information to the network device, where the response information is used to indicate the uplink rate of the first service.

In some implementations, if the terminal device or the first network element has not selected, from the first uplink rate range, the uplink rate of the first service that meets the association relationship with the stored downlink rate of the first service, the terminal device or the first network element transmits response information to the network device, where the response information is used to indicate that the network device re-initiates rate adjustment of the first service.

In some implementations, if the terminal device or the first network element has not selected, from the first uplink rate range, the uplink rate of the first service that meets the association relationship with the stored downlink rate of the first service, the terminal device or the first network element determines, based on the first association information, an uplink rate that is expected by the terminal device or the first network element for the first service, and transmits response information to the network device, where the response information is used to indicate the uplink rate that is expected by the terminal device or the first network element for the first service. For example, for the first association information, reference may be made to the three groups of uplink rates and downlink rates in Table 1. If the terminal device has not selected the uplink rate of the first service that meets the association relationship with the stored downlink rate of the first service, a rate pair in which a downlink rate is the same as the stored downlink rate of the first service is selected from Table 1, and the uplink rate in the rate pair is used as the uplink rate that is expected by the terminal device for the first service. For another example, for the first association information, reference may be made to the three groups of uplink rate ranges and downlink rate ranges in Table 2. If the terminal device has not selected the uplink rate of the first service that meets the association relationship with the stored downlink rate of the first service, a rate range pair in which the stored downlink rate of the first service is within a downlink rate range is selected from the three groups in Table 2, and a rate is selected from the uplink rate range in the rate range pair as the uplink rate that is expected by the terminal device for the first service.

It should be noted that a manner of carrying response information is the same as a manner of carrying response information in Implementation 2-1. For details, refer to the descriptions in Implementation 2-1. Details are not described herein again.

In some implementations, if the first information transmitted by the network device to the first network element includes the first uplink rate range and/or the first downlink rate range, and the response information indicates the uplink rate of the first service, after receiving the response information, the network device transmits the first information to the terminal device if the uplink rate, indicated by the response information, of the first service is different from a current uplink rate of the first service. The first information includes the uplink rate of the first service. The network device does not transmit the first information to the terminal device if the uplink rate, indicated by the response information, of the first service is the same as a current uplink rate of the first service. The network device first notifies the first network element of the first information, and the terminal device does not need the known first association information, which facilitates reduction of an information procedure of air interface transmission.

In some implementations, if the first information transmitted by the network device to the first network element includes the first uplink rate range and/or the first downlink rate range, and the response information indicates the uplink rate that is expected by the first network element for the first service, after receiving the response information, the network device transmits the first information to the terminal device if the uplink rate that is expected by the first network element for the first service and indicated by the response information is different from the current uplink rate of the first service and the network device accepts the uplink rate that is expected by the first network element for the first service. The first information includes the uplink rate of the first service. The uplink rate of the first service is the uplink rate that is expected by the first network element for the first service. The network device does not transmit the first information to the terminal device if the uplink rate that is expected by the first network element for the first service and indicated by the response information is the same as the current uplink rate of the first service.

In some implementations, if the first information transmitted by the network device to the terminal device includes the first uplink rate range and/or the first downlink rate range, and the response information indicates the downlink rate of the first service, after receiving the response information, the network device transmits the first information to the first network element if the downlink rate, indicated by the response information, of the first service is different from a current downlink rate of the first service. The first information includes the downlink rate of the first service. The network device does not transmit the first information to the terminal device if the downlink rate, indicated by the response information, of the first service is the same as a current downlink rate of the first service. The network device first notifies the terminal device of the first information. Because air interface information exchange is fast and convenient, the uplink rate of the first service of the terminal device may be quickly adjusted, which facilitates quick alleviation of congestion when network congestion occurs.

In some implementations, if the first information transmitted by the network device to the terminal device includes the first uplink rate range and/or the first downlink rate range, and the response information indicates the downlink rate that is expected by the terminal device for the first service, after receiving the response information, the network device transmits the first information to the first network element if the downlink rate that is expected by the terminal device for the first service and indicated by the response information is different from the current downlink rate of the first service and the network device accepts the uplink rate that is expected by the terminal device for the first service. The first information includes the downlink rate of the first service. The downlink rate of the first service is the downlink rate that is expected by the terminal device for the first service. The network device does not transmit the first information to the terminal device if the downlink rate of the first service that is indicated by the response information is the same as the current downlink rate of the first service.

In some implementations, if the response information indicates that the network device re-initiates rate adjustment of the first service, after receiving the response information, the network device may re-initiate a new round of rate adjustment of the first service, to determine a reasonable first uplink rate and/or a reasonable first downlink rate.

For ease of understanding, the following describes the solution in Implementation 2-2 with reference to FIG. 6 by using an example in which the network device learns that the first network element has learned of the first association information. FIG. 6 includes steps S610 and S640.

It is assumed that the first service is an XR service, the network device is an access network device, the access network device transmits first information to the first network element through the core network element, the first network element is an XR server, the access network device is a gNB, and the core network element includes an SMF and an AMF.

In step S610, the gNB transmits first information to the terminal device.

Based on wireless condition information, the gNB determines an uplink rate of the XR service and a first downlink rate range, and transmits the first information to the terminal device by using an RRC message. The RRC layer of the terminal device receives the first information, and notifies the application layer of the terminal device, where the first information includes the uplink rate of the XR service.

In step S620, the gNB transmits the first information to the XR server.

The gNB notifies the AMF of the first information by using an NG interface message, and then notifies the XR server of the first information through forwarding performed by the SMF. The first information includes an uplink rate of the XR service and a first downlink rate range.

In step S630, the XR server selects a downlink rate of the XR service from the first downlink rate range.

The XR server selects the downlink rate of the XR service from the first downlink rate range based on the first association information.

In step S640, the XR server transmits response information to the gNB.

If the XR server has selected the downlink rate of the XR service from the first downlink rate range, the response information transmitted by the XR server to the gNB indicates the downlink rate of the XR service. If the XR server has not selected the downlink rate of the XR service from the first downlink rate range, the response information transmitted by the XR server to the gNB indicates that the network device re-initiates rate adjustment of the XR service.

### Implementation 2-3: The First Information Includes the Uplink Rate of the First Service or the Downlink Rate of the First Service

In some implementations, if the first information received by the terminal device includes the uplink rate of the first service, the terminal device transmits response information to the network device, where the response information is used to indicate the downlink rate of the first service or the downlink rate range.

In some implementations, the downlink rate of the first service or the downlink rate range indicated by the response information is determined based on the association relationship.

In some implementations, the downlink rate or the downlink rate range is determined based on the association relationship. It may be understood that the terminal device receives the first information, and determines, based on the association relationship indicated by the first association information and the uplink rate of the first service that is included in the first information, the downlink rate of the first service or the downlink rate range that has an association relationship with the uplink rate of the first service. For example, for the first association information, reference may be made to Table 1. The terminal device receives the first information. The uplink rate of the first service that is included in the first information is C in Table 1. Therefore, the terminal device may determine, based on Table 1, that the downlink rate of the first service is D. For another example, for the first association information, reference may be made to Table 2. The terminal device receives the first information. The uplink rate of the first service that is included in the first information is within the range [C, D]. Therefore, the terminal device may determine that the downlink rate range of the first service is [C′, D′].

In some implementations, if the first information received by the first network element includes the downlink rate of the first service, the first network element transmits response information to the network device, where the response information is used to indicate the uplink rate of the first service or the uplink rate range.

In some implementations, the uplink rate of the first service or the uplink rate range indicated by the response information is determined based on the association relationship.

In some implementations, the uplink rate or the uplink rate range is determined based on the association relationship. It may be understood that the first network element receives the first information, and determines, based on the association relationship indicated by the first association information and the downlink rate of the first service that is included in the first information, the uplink rate of the first service or the uplink rate range that has an association relationship with the downlink rate of the first service. For example, for the first association information, reference may be made to Table 1. The first network element receives the first information. The downlink rate of the first service that is included in the first information is D in Table 1. Therefore, the first network element may determine, based on Table 1, that the uplink rate of the first service is C. For another example, for the first association information, reference may be made to Table 2. The first network element receives the first information. The downlink rate of the first service that is included in the first information is within the range [C′, D′]. Therefore, the terminal device may determine that the uplink rate range of the first service is [C, D].

In some implementations, after receiving the response information transmitted by the first network element, the network device transmits the first information to the terminal device, where the first information includes the uplink rate of the first service.

In some implementations, the network device receives the response information transmitted by the first network element. If the response information indicates the uplink rate range, the network device selects the uplink rate of the first service from the uplink rate range, and transmits the first information to the terminal device, where the first information includes the uplink rate of the first service. For example, if the uplink rate range of the first service that is indicated by the response information is [C, D], the network device selects a value C₁ from the uplink rate range as the uplink rate of the first service, and transmits the first information to the terminal device, where the first information includes the uplink rate C₁ of the first service.

It should be noted that a manner of carrying response information is the same as a manner of carrying response information in Implementation 2-1. For details, refer to the descriptions in Implementation 2-1. Details are not described herein again.

In some implementations, after receiving the response information transmitted by the terminal device, the network device transmits the first information to the first network element, where the first information includes the downlink rate of the first service.

In some implementations, the network device receives the response information transmitted by the terminal device. If the response information indicates the downlink rate range, the network device selects the downlink rate of the first service from the downlink rate range, and transmits the first information to the first network element, where the first information includes the downlink rate of the first service. For example, if the downlink rate range of the first service that is indicated by the response information is [C′, D′], the network device selects a value C′1 from the downlink rate range as the downlink rate of the first service, and transmits the first information to the first network element, where the first information includes the downlink rate C′₁ of the first service.

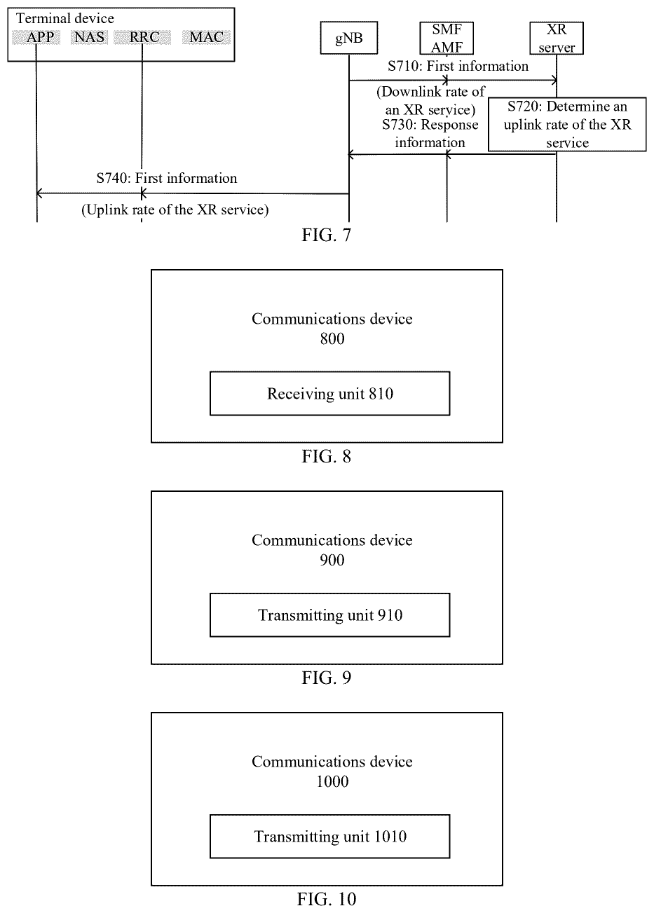

For ease of understanding, the following describes the solution in Implementation 2-3 with reference to FIG. 7 by using an example in which the network device learns that the first network element has learned of the first association information. FIG. 7 includes steps S710 to S740.

It is assumed that the first service is an XR service, the network device is an access network device, the access network device transmits first information to the first network element through the core network element, the first network element is an XR server, the access network device is a gNB, and the core network element includes an SMF and an AMF.

In step S710, the gNB transmits the first information to the XR server.

The gNB determines a downlink rate of the XR service based on a wireless condition. The gNB notifies the AMF of the first information by using an NG interface message, and then notifies the XR server of the first information through forwarding performed by the SMF. The first information includes the downlink rate of the XR service.

In step S720, the XR server determines an uplink rate of the XR service.

The XR server determines the uplink rate of the XR service based on the first association information.

In step S730, the XR server transmits response information to the gNB.

The response information transmitted by the XR server to the gNB indicates the uplink rate of the XR service.

In step S740, the gNB transmits the first information to the XR server.

The gNB receives the response information, and transmits the first information to the terminal device by using an RRC message. The RRC layer of the terminal device receives the first information, to notify the application layer of the terminal device. The first information includes the uplink rate of the XR service.

By using the three implementations, the foregoing separately describes a method in which the network device does not obtain the first association information, and transmits the first information to the terminal device and/or the first network element, to adjust a rate of the first service. In some scenarios, the foregoing three implementations may be used separately. In some other scenarios, the foregoing three implementations may be used in combination. The following describes a method of combining the three implementations.

In some implementations, when Implementation 2-1 is combined with Implementation 2-2, the network device transmits first information to the terminal device or the first network element, where the first information includes the first uplink rate and the first downlink rate range. The terminal device or the first network element determines, based on the first association information, whether the first uplink rate is reasonable. If the first uplink rate is reasonable, the terminal device or the first network element selects the downlink rate of the first service from the first downlink rate range.

In some implementations, if the first association information includes the uplink rate and/or the downlink rate, determining whether the first uplink rate is reasonable may be understood as: determining whether the first uplink rate is the same as the uplink rate; and if the first uplink rate is the same as the uplink rate, determining that the first uplink rate is reasonable; or if the first uplink rate is different from the uplink rate, determining that the first uplink rate is unreasonable.

In some implementations, if the first association information includes the uplink rate range and/or the downlink rate range, determining whether the first uplink rate is reasonable may be understood as: determining whether the first uplink rate is within the uplink rate range; and if the first uplink rate is within the uplink rate range, determining that the first uplink rate is reasonable; or if the first uplink rate is not within the uplink rate range, determining that the first uplink rate is unreasonable.

In some implementations, if the first association information includes the uplink rate and/or the downlink rate, and the first uplink rate is reasonable, selecting the downlink rate of the first service from the first downlink rate range may be understood as: from the plurality of groups of uplink rates and downlink rates indicated by the first association information, selecting a rate pair in which an uplink rate is the same as the first uplink rate and a downlink rate is within the first downlink rate range, using the uplink rate in the rate pair as the uplink rate of the first service, and using the downlink rate in the rate pair as the downlink rate of the first service For example, the first association information includes the uplink rate and the first ratio. For the first association information, reference may be made to Table 3. Table 3 indicates the three groups of uplink rates and downlink rates. From the three groups of uplink rates and downlink rates, a rate pair in which an uplink rate is the same as the first uplink rate and a downlink rate is within the first downlink rate range is selected, the uplink rate in the rate pair is used as the uplink rate of the first service, and the downlink rate in the rate pair is used as the downlink rate of the first service.

In some implementations, if the first association information includes the uplink rate range and/or the downlink rate range, and the first uplink rate is reasonable, selecting, from the first downlink rate range, the downlink rate of the first service may be understood as: from the plurality of groups of uplink rate ranges and downlink rate ranges indicated by the first association information, selecting a rate range pair in which the first uplink rate is within an uplink rate range and an intersection set exits between a downlink rate range and the first downlink rate range, selecting the downlink rate of the first service from the intersection set between the downlink rate range and the first downlink rate range, and using the first uplink rate as the uplink rate of the first service. For example, for the first association information, reference may be made to Table 2. Table 2 indicates the three groups of uplink rate ranges and downlink rate ranges. From the three groups of uplink rate ranges and downlink rate ranges, a rate range pair in which the first uplink rate is within an uplink rate range and an intersection set exists between a downlink rate range and the first downlink rate range is selected, the downlink rate of the first service is selected from the intersection set between the downlink rate range in the rate range pair and the first downlink rate range, and the first uplink rate is used as the uplink rate of the first service.

In some implementations, if it is determined that the first uplink rate is reasonable and the downlink rate of the first service is selected from the first downlink rate range, the terminal device or the first network element transmits response information to the network device, where the response information indicates that the first uplink rate is the uplink rate of the first service, and the downlink rate of the first service.

In some implementations, if it is determined that the first uplink rate is unreasonable, and/or the downlink rate of the first service is not selected from the first downlink rate range, the terminal device or the first network element transmits response information to the network device, where the response information indicates one or more of the following: that the network device re-initiates rate adjustment of the first service; or at least one of the uplink rate or the downlink rate that is expected by the terminal device or the first network element for the first service.

In some implementations, when Implementation 2-1 is combined with Implementation 2-2, the network device transmits first information to the terminal device or the first network element, where the first information includes the first downlink rate and the first uplink rate range. The terminal device or the first network element determines, based on the first association information, whether the first downlink rate is reasonable. If the first downlink rate is reasonable, the terminal device or the first network element selects the uplink rate of the first service from the first uplink rate range.

In some implementations, if the first association information includes the uplink rate and/or the downlink rate, determining whether the first downlink rate is reasonable may be understood as: determining whether the first downlink rate is the same as the downlink rate; and if the first downlink rate is the same as the downlink rate, determining that the first downlink rate is reasonable; or if the first downlink rate is different from the downlink rate, determining that the first downlink rate is unreasonable.

In some implementations, if the first association information includes the uplink rate range and/or the downlink rate range, determining whether the first downlink rate is reasonable may be understood as: determining whether the first downlink rate is within the downlink rate range; and if the first downlink rate is within the downlink rate range, determining that the first downlink rate is reasonable; or if the first downlink rate is not within the downlink rate range, determining that the first downlink rate is unreasonable.

In some implementations, if the first association information includes the uplink rate and/or the downlink rate, and the first downlink rate is reasonable, selecting the uplink rate of the first service from the first uplink rate range may be understood as: from the plurality of groups of uplink rates and downlink rates indicated by the first association information, selecting a rate pair in which a downlink rate is the same as the first downlink rate and an uplink rate is within the first uplink rate range, using the uplink rate in the rate pair as the uplink rate of the first service, and using the downlink rate in the rate pair as the downlink rate of the first service. For example, the first association information includes the uplink rate and the first ratio. For the first association information, reference may be made to Table 3. Table 3 indicates the three groups of uplink rates and downlink rates. From the three groups of uplink rates and downlink rates, a rate pair in which a downlink rate is the same as the first downlink rate and an uplink rate is within the first uplink rate range is selected, the uplink rate in the rate pair is used as the uplink rate of the first service, and the downlink rate in the rate pair is used as the downlink rate of the first service.

In some implementations, if the first association information includes the uplink rate range and/or the downlink rate range, and the first downlink rate is reasonable, selecting, from the first uplink rate range, the uplink rate of the first service may be understood as: from the plurality of groups of uplink rate ranges and downlink rate ranges indicated by the first association information, selecting a rate range pair in which the first downlink rate is within a downlink rate range and an intersection set exits between an uplink rate range and the first uplink rate range, selecting the uplink rate of the first service from the intersection set between the uplink rate range and the first uplink rate range, and using the first downlink rate as the downlink rate of the first service. For example, for the first association information, reference may be made to Table 2. Table 2 indicates the three groups of uplink rate ranges and downlink rate ranges. From the three groups of uplink rate ranges and downlink rate ranges, a rate range pair in which the first downlink rate is within a downlink rate range and an intersection set exists between an uplink rate range and the first uplink rate range is selected, the uplink rate of the first service is selected from the intersection set between the uplink rate range in the rate range pair and the first uplink rate range, and the first downlink rate is used as the downlink rate of the first service.

In some implementations, if it is determined that the first downlink rate is reasonable and the uplink rate of the first service is selected from the first uplink rate, the terminal device or the first network element transmits response information to the network device, where the response information indicates that the first downlink rate is the downlink rate of the first service, and the uplink rate of the first service.

In some implementations, if it is determined that the first downlink rate is unreasonable, and/or the uplink rate of the first service is not selected from the first uplink rate range, the terminal device or the first network element transmits response information to the network device, where the response information indicates one or more of the following: that the network device re-initiates rate adjustment of the first service; or at least one of the uplink rate or the downlink rate that is expected by the terminal device or the first network element for the first service.

The method embodiments of the present application are described in detail above with reference to FIG. 1 to FIG. 7. Apparatus embodiments of the present application are described in detail below with reference to FIG. 8 to FIG. 11. It should be understood that the description of the method embodiments corresponds to the description of the apparatus embodiments, and therefore, for a part that is not described in detail, reference may be made to the foregoing method embodiments.

FIG. 8 is a schematic diagram of a structure of a communications device according to an embodiment of the present application. The communications device 800 shown in FIG. 8 is a terminal device. The communications device 800 includes a receiving unit 810.

The receiving unit 810 is configured to receive first information transmitted by a network device, where the first information is used to determine an uplink rate and/or a downlink rate of a first service, and an association relationship exists between the uplink rate and the downlink rate.

In some implementations, at least one of the uplink rate or the downlink rate is determined based on a wireless condition.

In some implementations, the first information includes one or more of the following: the downlink rate of the first service; the uplink rate of the first service; a first uplink rate, where the first uplink rate is an uplink rate that is expected by the network device for the first service; a first downlink rate, where the first uplink rate is a downlink rate that is expected by the network device for the first service; a first uplink rate range, where the first uplink rate range is a range of an uplink rate that is expected by the network device for the first service; or a first downlink rate range, where the first uplink rate range is a range of a downlink rate that is expected by the network device for the first service.

In some implementations, before the terminal device receives the first information, the communications device further includes: a transmitting unit, transmitting first association information to the network device, where the first association information is used to indicate the association relationship between the uplink rate and the downlink rate.

In some implementations, the first association information includes one or more of the following: a first index, where the first index is used to indicate a combination of the uplink rate and the downlink rate, or a combination of a range of the uplink rate and a range of the downlink rate; the uplink rate; the downlink rate; a range of the uplink rate; a range of the downlink rate; or a first parameter, where the first parameter is used to determine the downlink rate or a range of the downlink rate based on the uplink rate or a range of the uplink rate, or determine the uplink rate or a range of the uplink rate based on the downlink rate or a range of the downlink rate.

In some implementations, the first parameter is used to indicate one or more of the following: an offset value between the uplink rate and the downlink rate; a ratio between the uplink rate and the downlink rate; a ratio between the downlink rate and the uplink rate; an offset value between an upper boundary of the range of the uplink rate and an upper boundary of the range of the downlink rate; an offset value between a lower boundary of the range of the uplink rate and a lower boundary of the range of the downlink rate; a ratio between an upper boundary of the range of the downlink rate and an upper boundary of the range of the uplink rate; a ratio between a lower boundary of the range of the downlink rate and a lower boundary of the range of the uplink rate; a ratio between an upper boundary of the range of the uplink rate and an upper boundary of the range of the downlink rate; or a ratio between a lower boundary of the range of the uplink rate and a lower boundary of the range of the downlink rate.

In some implementations, if the first information includes the first uplink rate and/or the first downlink rate, the communications device further includes: a determining unit, where if the first uplink rate and the first downlink rate meet the association relationship, the determining unit is configured to determine that the first uplink rate is an uplink rate of the first service, and the first downlink rate is a downlink rate of the first service; or if the uplink rate of the first service and the first downlink rate meet the association relationship, the determining unit is configured to determine that the first downlink rate is a downlink rate of the first service.

In some implementations, if the first information includes the first uplink rate range and/or the first downlink rate range, the communications device further includes: a selection unit, selecting the uplink rate and/or the downlink rate of the first service from the first uplink rate range and/or the first downlink rate range based on the association relationship.

In some implementations, the communications device further includes: a transmitting unit, transmitting response information to the network device, where the response information is used to indicate one or more of following: whether the first uplink rate is the uplink rate of the first service; whether the first downlink rate is the downlink rate of the first service; the uplink rate and/or the downlink rate of the first service; at least one of the uplink rate or the downlink rate that is expected by the terminal device for the first service; or that the network device re-initiates rate adjustment of the first service.

In some implementations, if the first information includes the uplink rate of the first service, the communications device further includes: a transmitting unit, transmitting response information to the network device, where the response information is used to indicate the downlink rate or a range of the downlink rate, and the downlink rate or the range of the downlink rate is determined based on the association relationship.

In some implementations, the first information is carried in a radio resource control RRC message or a medium access control control element MAC CE.

FIG. 9 is a schematic diagram of a structure of a communications device according to an embodiment of the present application. The communications device 900 shown in FIG. 9 is a network device. The communications device 900 includes a transmitting unit 910.

The transmitting unit 910 is configured to transmit first information to a terminal device and/or a first network element, where the first information is used to determine an uplink rate and/or a downlink rate of a first service, and an association relationship exists between the uplink rate and the downlink rate.

In some implementations, at least one of the uplink rate or the downlink rate is determined based on a wireless condition.

In some implementations, the first information includes one or more of the following: the downlink rate of the first service; the uplink rate of the first service; a first uplink rate, where the first uplink rate is an uplink rate that is expected by the network device for the first service; a first downlink rate, where the first uplink rate is a downlink rate that is expected by the network device for the first service; a first uplink rate range, where the first uplink rate range is a range of an uplink rate that is expected by the network device for the first service; or a first downlink rate range, where the first uplink rate range is a range of a downlink rate that is expected by the network device for the first service.

In some implementations, before the network device transmits the first information, the communications device further includes: a receiving unit, receiving first association information transmitted by the terminal device or the first network element, where the first association information is used to indicate the association relationship between the uplink rate and the downlink rate.

In some implementations, the first association information includes one or more of the following: a first index, where the first index is used to indicate a combination of the uplink rate and the downlink rate, or a combination of a range of the uplink rate and a range of the downlink rate; the uplink rate; the downlink rate; a range of the uplink rate; a range of the downlink rate; or a first parameter, where the first parameter is used to determine the downlink rate or a range of the downlink rate based on the uplink rate or a range of the uplink rate, or determine the uplink rate or a range of the uplink rate based on the downlink rate or a range of the downlink rate.

In some implementations, the first parameter is used to indicate one or more of the following: an offset value between the uplink rate and the downlink rate; a ratio between the uplink rate and the downlink rate; a ratio between the downlink rate and the uplink rate; an offset value between an upper boundary of the range of the uplink rate and an upper boundary of the range of the downlink rate; an offset value between a lower boundary of the range of the uplink rate and a lower boundary of the range of the downlink rate; a ratio between an upper boundary of the range of the downlink rate and an upper boundary of the range of the uplink rate; a ratio between a lower boundary of the range of the downlink rate and a lower boundary of the range of the uplink rate; a ratio between an upper boundary of the range of the uplink rate and an upper boundary of the range of the downlink rate; or a ratio between a lower boundary of the range of the uplink rate and a lower boundary of the range of the downlink rate.

In some implementations, if the first information includes the first uplink rate and/or the first downlink rate, or the first uplink rate range and/or the first downlink rate range, the communications device further includes: a receiving unit, receiving response information transmitted by the terminal device or the first network element, where the response information is used to indicate one or more of following: whether the first uplink rate is the uplink rate of the first service; whether the first downlink rate is the downlink rate of the first service; the uplink rate and/or the downlink rate of the first service; at least one of the uplink rate or the downlink rate that is expected by the terminal device or the first network element for the first service; or that the network device re-initiates rate adjustment of the first service.

In some implementations, if the first information includes the uplink rate of the first service and/or the downlink rate of the first service, the communications device further includes: a receiving unit, receiving response information transmitted by the terminal device, where the response information is used to indicate the downlink rate or a range of the downlink rate, and the downlink rate or the range of the downlink rate is determined based on the association relationship; or receiving, by the network device, response information transmitted by the first network element, where the response information is used to indicate the uplink rate or a range of the uplink rate, and the uplink rate or the range of the uplink rate is determined based on the association relationship.

In some implementations, the first information is carried in a radio resource control RRC message or a medium access control control element MAC CE; or the first information is carried in an NG interface message.

FIG. 10 is a schematic diagram of a structure of a communications device according to an embodiment of the present application. The communications device 1000 shown in FIG. 10 is a first network element. The communications device 1000 includes a receiving unit 1010.

The receiving unit 1010 is configured to receive first information transmitted by a network device, where the first information is used to determine an uplink rate and/or a downlink rate of a first service, and an association relationship exists between the uplink rate and the downlink rate.

In some implementations, at least one of the uplink rate or the downlink rate is determined based on a wireless condition.

In some implementations, the first information includes one or more of the following: the downlink rate of the first service; the uplink rate of the first service; a first uplink rate, where the first uplink rate is an uplink rate that is expected by the network device for the first service; a first downlink rate, where the first uplink rate is a downlink rate that is expected by the network device for the first service; a first uplink rate range, where the first uplink rate range is a range of an uplink rate that is expected by the network device for the first service; or a first downlink rate range, where the first uplink rate range is a range of a downlink rate that is expected by the network device for the first service.

In some implementations, before the first network element receives the first information, the communications device further includes: a transmitting unit, transmitting first association information to the network device, where the first association information is used to indicate the association relationship between the uplink rate and the downlink rate.

In some implementations, the first association information includes one or more of the following: a first index, where the first index is used to indicate a combination of the uplink rate and the downlink rate, or a combination of a range of the uplink rate and a range of the downlink rate; the uplink rate; the downlink rate; a range of the uplink rate; a range of the downlink rate; or a first parameter, where the first parameter is used to determine the downlink rate or a range of the downlink rate based on the uplink rate or a range of the uplink rate, or determine the uplink rate or a range of the uplink rate based on the downlink rate or a range of the downlink rate.

In some implementations, the first parameter is used to indicate one or more of the following: an offset value between the uplink rate and the downlink rate; a ratio between the uplink rate and the downlink rate; a ratio between the downlink rate and the uplink rate; an offset value between an upper boundary of the range of the uplink rate and an upper boundary of the range of the downlink rate; an offset value between a lower boundary of the range of the uplink rate and a lower boundary of the range of the downlink rate; a ratio between an upper boundary of the range of the downlink rate and an upper boundary of the range of the uplink rate; a ratio between a lower boundary of the range of the downlink rate and a lower boundary of the range of the uplink rate; a ratio between an upper boundary of the range of the uplink rate and an upper boundary of the range of the downlink rate; or a ratio between a lower boundary of the range of the uplink rate and a lower boundary of the range of the downlink rate.

In some implementations, if the first information includes the first uplink rate and/or the first downlink rate, the communications device further includes: a determining unit, where if the first uplink rate and the first downlink rate meet the association relationship, the determining unit is configured to determine that the first uplink rate is an uplink rate of the first service, and the first downlink rate is a downlink rate of the first service; or if the uplink rate of the first service and the first downlink rate meet the association relationship, the determining unit is configured to determine that the first downlink rate is a downlink rate of the first service.

In some implementations, if the first information includes the first uplink rate range and/or the first downlink rate range, the communications device further includes: a selection unit, selecting the uplink rate and/or the downlink rate of the first service from the first uplink rate range and/or the first downlink rate range based on the association relationship.

In some implementations, the communications device further includes: a transmitting unit, transmitting response information to the network device, where the response information is used to indicate one or more of following: whether the first uplink rate is the uplink rate of the first service; whether the first downlink rate is the downlink rate of the first service; the uplink rate and/or the downlink rate of the first service; at least one of the uplink rate or the downlink rate that is expected by the first network element for the first service; or that the network device re-initiates rate adjustment of the first service.

In some implementations, if the first information includes the uplink rate of the first service, the communications device further includes: a transmitting unit, transmitting response information to the network device, where the response information is used to indicate the downlink rate or a range of the downlink rate, and the downlink rate or the range of the downlink rate is determined based on the association relationship.

In some implementations, the first information is carried in an NG interface message.

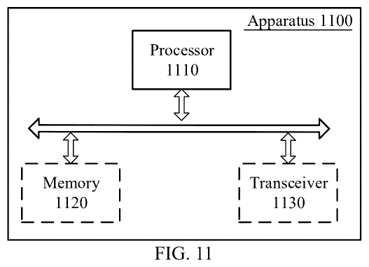

In an optional embodiment, the receiving unit 810 may be a transceiver 1130. The communications device 800 may further include a processor 1110 and a memory 1120, which are specifically shown in FIG. 11.

In an optional embodiment, the transmitting unit 910 may be a transceiver 1130. The communications device 900 may further include a processor 1110 and a memory 1120, which are specifically shown in FIG. 11.

In an optional embodiment, the receiving unit 1010 may be a transceiver 1130. The communications device 1000 may further include a processor 1110 and a memory 1120, which are specifically shown in FIG. 11.

FIG. 11 is a schematic structural diagram of a communications apparatus according to an embodiment of the present application. Dashed lines in FIG. 11 indicate that a unit or module is optional. The apparatus 1100 may be configured to implement the methods described in the foregoing method embodiments. The apparatus 1100 may be a chip, a terminal device, or a network device.

The apparatus 1100 may include one or more processors 1110. The processor 1110 may support the apparatus 1100 in implementing the methods described in the foregoing method embodiments. The processor 1110 may be a general-purpose processor or a dedicated processor. For example, the processor may be a central processing unit (central processing unit, CPU). Alternatively, the processor may be another general-purpose processor, a digital signal processor (digital signal processor, DSP), an application specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1100 may further include one or more memories 1120. The memory 1120 stores a program, and the program may be executed by the processor 1110, so that the processor 1110 executes the method described in the foregoing method embodiments. The memory 1120 may be separate from the processor 1110 or may be integrated into the processor 1110.

The apparatus 1100 may further include a transceiver 1130. The processor 1110 may communicate with another device or chip by using the transceiver 1130. For example, the processor 1110 may transmit data to and receive data from another device or chip by using the transceiver 1130.

An embodiment of the present application further provides a computer-readable storage medium for storing a program. The computer-readable storage medium may be applied to the terminal device or the network device provided in embodiments of the present application, and the program causes a computer to execute the methods performed by the terminal device or the network device in various embodiments of the present application.

An embodiment of the present application further provides a computer program product. The computer program product includes a program. The computer program product may be applied to the terminal device or the network device provided in embodiments of the present application, and the program causes a computer to perform the methods performed by the terminal device or the network device in various embodiments of the present application.

An embodiment of the present application further provides a computer program. The computer program may be applied to a terminal device or a network device provided in embodiments of the present application, and the computer program causes a computer to perform the methods performed by the terminal device or the network device in various embodiments of the present application.

It should be understood that the terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular sequence. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained through A; or may mean that A indirectly indicates B, for example, A indicates C, and B may be obtained by using C; or may mean that there is an association relationship between A and B.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “pre-definition” or “pre-configuration” may be implemented by pre-storing corresponding code, tables, or other forms that may be used to indicate related information in a device (for example, including a terminal device and a network device). A specific implementation thereof is not limited in the present application. For example, pre-definition may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined according to functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, the apparatuses or units, and may be implemented in electronic, mechanical, or another form.

The units described as separate parts may be or may not be physically separate, and parts displayed as units may be or may not be physical units, and may be at one location, or may be distributed on a plurality of network elements. A part or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

All or a part of the foregoing embodiments may be implemented through software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
receiving, by a terminal device, first information from a network device, wherein the first information is used to determine at least one of an uplink rate or a downlink rate of a first service, and an association relationship exists between the uplink rate and the downlink rate.

2. The method according to claim 1, wherein at least one of the uplink rate or the downlink rate is determined based on a wireless condition.

3. The method according to claim 1, wherein the first information comprises one or more of following:
the downlink rate of the first service;
the uplink rate of the first service;
a first uplink rate, wherein the first uplink rate is an uplink rate that is expected by the network device for the first service;
a first downlink rate, wherein the first downlink rate is a downlink rate that is expected by the network device for the first service;
a first uplink rate range, wherein the first uplink rate range is a range of an uplink rate that is expected by the network device for the first service; or
a first downlink rate range, wherein the first uplink rate range is a range of a downlink rate that is expected by the network device for the first service.

4. The method according to claim 1, wherein before the receiving, by a terminal device, first information, the method further comprises:
transmitting, by the terminal device, first association information to the network device, wherein the first association information indicates the association relationship between the uplink rate and the downlink rate.

5. The method according to claim 4, wherein the first association information comprises one or more of following:
a first index, wherein the first index is used to indicate a combination of the uplink rate and the downlink rate, or a combination of a range of the uplink rate and a range of the downlink rate;
the uplink rate;
the downlink rate;
a range of the uplink rate;
a range of the downlink rate; or
a first parameter, wherein the first parameter is used to determine the downlink rate or a range of the downlink rate based on the uplink rate or a range of the uplink rate, or determine the uplink rate or a range of the uplink rate based on the downlink rate or a range of the downlink rate.

6. The method according to claim 5, wherein the first parameter indicates one or more of following:
an offset value between the uplink rate and the downlink rate;
a ratio between the uplink rate and the downlink rate;
a ratio between the downlink rate and the uplink rate;
an offset value between an upper boundary of the range of the uplink rate and an upper boundary of the range of the downlink rate;
an offset value between a lower boundary of the range of the uplink rate and a lower boundary of the range of the downlink rate;
a ratio between an upper boundary of the range of the downlink rate and an upper boundary of the range of the uplink rate;
a ratio between a lower boundary of the range of the downlink rate and a lower boundary of the range of the uplink rate;
a ratio between an upper boundary of the range of the uplink rate and an upper boundary of the range of the downlink rate; or
a ratio between a lower boundary of the range of the uplink rate and a lower boundary of the range of the downlink rate.

7. The method according to claim 3, wherein the first information comprises at least one of the first uplink rate or the first downlink rate, and the method further comprises:
when the first uplink rate and the first downlink rate meet the association relationship, determining, by the terminal device, that the first uplink rate is an uplink rate of the first service, and the first downlink rate is a downlink rate of the first service; or
when the uplink rate of the first service and the first downlink rate meet the association relationship, determining, by the terminal device, that the first downlink rate is a downlink rate of the first service.

8. The method according to claim 3, wherein the first information comprises at least one of the first uplink rate range or the first downlink rate range, the method further comprises:
selecting, by the terminal device, at least one of the uplink rate or the downlink rate of the first service from at least one of the first uplink rate range or the first downlink rate range based on the association relationship.

9. The method according to claim 7, wherein the method further comprises:
transmitting, by the terminal device, response information to the network device, wherein the response information indicates one or more of following:
whether the first uplink rate is the uplink rate of the first service;
whether the first downlink rate is the downlink rate of the first service;
the uplink rate and/or the downlink rate of the first service;
at least one of the uplink rate or the downlink rate that is expected by the terminal device for the first service; or
that the network device re-initiates rate adjustment of the first service.

10. The method according to claim 3, wherein the first information comprises the uplink rate of the first service, and the method further comprises:
transmitting, by the terminal device, response information to the network device, wherein the response information indicates the downlink rate or a range of the downlink rate, and the downlink rate or the range of the downlink rate is determined based on the association relationship.

11. The method according to claim 1, wherein the first information is carried in a radio resource control (RRC) message or a medium access control control element (MAC CE).

12. A wireless communication method, comprising:
transmitting, by a network device, first information to at least one of a terminal device or a first network element, wherein the first information is used to determine at least one of an uplink rate or a downlink rate of a first service, and an association relationship exists between the uplink rate and the downlink rate.

13. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving first information from a network device, wherein the first information is used to determine at least one of an uplink rate or a downlink rate of a first service, and an association relationship exists between the uplink rate and the downlink rate.

14. The apparatus according to claim 13, wherein at least one of the uplink rate or the downlink rate is determined based on a wireless condition.

15. The apparatus according to claim 13, wherein the first information comprises one or more of following:
the downlink rate of the first service;
the uplink rate of the first service;
a first uplink rate, wherein the first uplink rate is an uplink rate that is expected by the network device for the first service;
a first downlink rate, wherein the first downlink rate is a downlink rate that is expected by the network device for the first service;
a first uplink rate range, wherein the first uplink rate range is a range of an uplink rate that is expected by the network device for the first service; or
a first downlink rate range, wherein the first uplink rate range is a range of a downlink rate that is expected by the network device for the first service.

16. The apparatus according to claim 13, wherein the operations comprise:
before the receiving the first information, transmitting first association information to the network device, wherein the first association information indicates the association relationship between the uplink rate and the downlink rate.

17. The apparatus according to claim 16, wherein the first association information comprises one or more of following:
a first index, wherein the first index is used to indicate a combination of the uplink rate and the downlink rate, or a combination of a range of the uplink rate and a range of the downlink rate;
the uplink rate;
the downlink rate;
a range of the uplink rate;
a range of the downlink rate; or
a first parameter, wherein the first parameter is used to determine the downlink rate or a range of the downlink rate based on the uplink rate or a range of the uplink rate, or determine the uplink rate or a range of the uplink rate based on the downlink rate or a range of the downlink rate.

18. The apparatus according to claim 17, wherein the first parameter indicates one or more of following:
an offset value between the uplink rate and the downlink rate;
a ratio between the uplink rate and the downlink rate;
a ratio between the downlink rate and the uplink rate;
an offset value between an upper boundary of the range of the uplink rate and an upper boundary of the range of the downlink rate;
an offset value between a lower boundary of the range of the uplink rate and a lower boundary of the range of the downlink rate;
a ratio between an upper boundary of the range of the downlink rate and an upper boundary of the range of the uplink rate;
a ratio between a lower boundary of the range of the downlink rate and a lower boundary of the range of the uplink rate;
a ratio between an upper boundary of the range of the uplink rate and an upper boundary of the range of the downlink rate; or
a ratio between a lower boundary of the range of the uplink rate and a lower boundary of the range of the downlink rate.

19. The apparatus according to claim 15, wherein the first information comprises at least one of the first uplink rate or the first downlink rate, and the operations further comprise:
when the first uplink rate and the first downlink rate meet the association relationship, determining that the first uplink rate is an uplink rate of the first service, and the first downlink rate is a downlink rate of the first service; or
when the uplink rate of the first service and the first downlink rate meet the association relationship, determining, by the terminal device, that the first downlink rate is a downlink rate of the first service.

20. The apparatus according to claim 15, wherein the first information comprises at least one of the first uplink rate range or the first downlink rate range, the operations further comprise:
selecting, by the terminal device, at least one of the uplink rate or the downlink rate of the first service from at least one of the first uplink rate range or the first downlink rate range based on the association relationship.
